(19) United States
(12) Patent Application Publication
(10) Pub. No.: US 2026/0289259 A1
(43) Pub. Date: Sep. 24, 2026

(54) SYSTEM

(71) Applicant: SoftBank Group Corp., Tokyo (JP)

(72) Inventor: Satoshi UMEDA, Tokyo (JP)

(73) Assignee: SoftBank Group Corp., Tokyo (JP)

(21) Appl. No.: 19/564,270

(22) Filed: Mar. 12, 2026

(30) Foreign Application Priority Data
Mar. 19, 2025 (JP) 2025-044949

(51) Int. Cl. G06N 3/0475; G06F 40/197; G06F 40/289; G06N 3/09

(52) U.S. Cl. CPC G06N 3/0475; G06F 40/197; G06F 40/289; G06N 3/09

(57) ABSTRACT

A system includes a processor that is configured to generate a prompt for instructing generation of a draft amendment to a regulation based on at least one of a legal revision and a change of an officer position within an organization, generate, by using a generative artificial intelligence model, the draft amendment to the regulation based on the prompt, and notify stakeholders of the generated draft amendment via an electronic workflow system.

### CROSS-REFERENCE TO RELATED APPLICATION

This application is based on and claims priority under 35 USC 119 from Japanese Patent Application No. 2025-044949 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional regulation management systems rely heavily on manual work by compliance officers and administrators when legal revisions occur or when officers and positions within an organization change. In such systems, responsible personnel must manually analyze the impact of legal revisions and organizational changes, manually draft amendment proposals for relevant regulations, and manually circulate those draft amendments via email or document management tools. This manual process is time-consuming, prone to human error, and may lead to inconsistencies among regulations, delays in reflecting mandatory legal changes, and insufficient traceability of who changed what and when.

Furthermore, conventional systems often do not systematically manage revision history in a structured database. As a result, it is difficult to trace changes in regulations over time, to audit the reasons for individual amendments, or to verify compliance with legal and internal governance requirements. The lack of chronological and searchable history reduces transparency and weakens corporate governance.

In addition, conventional systems do not effectively leverage generative artificial intelligence to assist users in understanding how regulations should be applied in concrete situations. Even when regulations are correctly maintained, employees and stakeholders may find it difficult to interpret and apply the regulations to specific cases. This leads to frequent inquiries to compliance departments, inconsistent application of rules, and a higher risk of non-compliance.

Accordingly, there is a need for a system that can automatically assist in creating draft amendment proposals for regulations based on legal revisions and organizational officer changes, that can reliably record and manage revision history in a database in chronological order, and that can generate and present application examples of regulations using a generative artificial intelligence model to facilitate user understanding and consistent application of the regulations.

### SUMMARY

In order to solve the above-described problems, the present invention provides a system comprising a processor, wherein the processor is configured to generate a prompt for instructing generation of a draft amendment to a regulation based on at least one of a legal revision and a change of an officer position within an organization, generate, by using a generative artificial intelligence model, the draft amendment to the regulation based on the prompt, and notify stakeholders of the generated draft amendment via an electronic workflow system. By automatically generating prompts and draft amendments using the generative artificial intelligence model, and by distributing the draft amendments through the electronic workflow system, the system reduces manual workload, shortens the time required to update regulations, and lowers the risk of human error.

The processor is further configured to store revision history in a database and manage history information in chronological order, in order to record the revision history. By storing revision history in a structured and time-ordered manner, the system enables stakeholders to trace past amendments, understand the reasons and responsible persons for each change, and perform audits and governance checks efficiently, thereby enhancing transparency and accountability in regulation management.

Moreover, the processor is configured to generate a prompt for instructing generation of an application example of the regulation by using the generative artificial intelligence model, and present the application example to the stakeholders in order to show the application example of the regulation. By generating and presenting such application examples, the system supports users in understanding how the regulation should be applied in specific scenarios, promotes consistent rule application across the organization, and reduces the burden on compliance and legal departments in responding to routine inquiries. Through these combined means, the invention provides an integrated solution for efficient amendment, transparent history management, and practical understanding of regulations.

The term “system” refers to a combination of hardware and software components, including at least one processor, memory, storage, and communication interfaces, configured to perform the operations recited in the claims.

The term “processor” refers to one or more hardware processing units, such as a central processing unit (CPU), graphics processing unit (GPU), application-specific integrated circuit (ASIC), or programmable logic device, that execute instructions to perform the functions described in the claims.

The term “regulation” refers to an internal rule, policy, standard, guideline, procedure, or similar documented control established within an organization to govern behavior, operations, or compliance with external laws or regulations.

The term “draft amendment” refers to a proposed modification of at least a part of a regulation, including additions, deletions, or changes of text or provisions, which is subject to review and approval before becoming effective as a finalized regulation.

The term “legal revision” refers to a change in an external legal source, such as a law, ordinance, regulation, or official guideline, that may require a corresponding update of one or more regulations within an organization.

The term “change of an officer position within an organization” refers to an event in which a person holding a specific role, title, or position in the organizational hierarchy is replaced, newly appointed, removed, or reassigned, including changes in the identification of the person associated with that position.

The term “prompt” refers to information, including text or structured data, generated by the processor to instruct or guide a generative artificial intelligence model regarding the content, purpose, or constraints for generating a draft amendment or an application example of a regulation.

The term “generative artificial intelligence model” refers to a machine learning model, such as a neural network-based language model, configured to generate text or other content in response to a given prompt, including but not limited to large language models.

The term “electronic workflow system” refers to a software-based system that electronically manages, routes, and records tasks, documents, and approvals among multiple users or roles, and that is used to notify stakeholders of draft amendments and to facilitate review and approval processes.

The term “stakeholder” refers to a person or role within or associated with an organization who is involved in, responsible for, or affected by a regulation or its amendment, including but not limited to approvers, administrators, compliance officers, and general employees.

The term “revision history” refers to information that records changes made to a regulation over time, including at least one of previous versions, new versions, dates of changes, reasons for changes, and identities of persons responsible for proposing or approving the changes.

The term “database” refers to an organized collection of data stored on a non-transitory computer-readable medium and managed by database software, in which revision history and related information are stored and retrieved according to the functions described in the claims.

The term “history information in chronological order” refers to revision history data that is recorded and maintained in association with timestamps or version identifiers so that the sequence of changes can be identified and reconstructed in time order.

The term “application example of the regulation” refers to a description or scenario, generated using the generative artificial intelligence model, that illustrates how a specific regulation is to be interpreted or applied in a concrete or hypothetical case.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

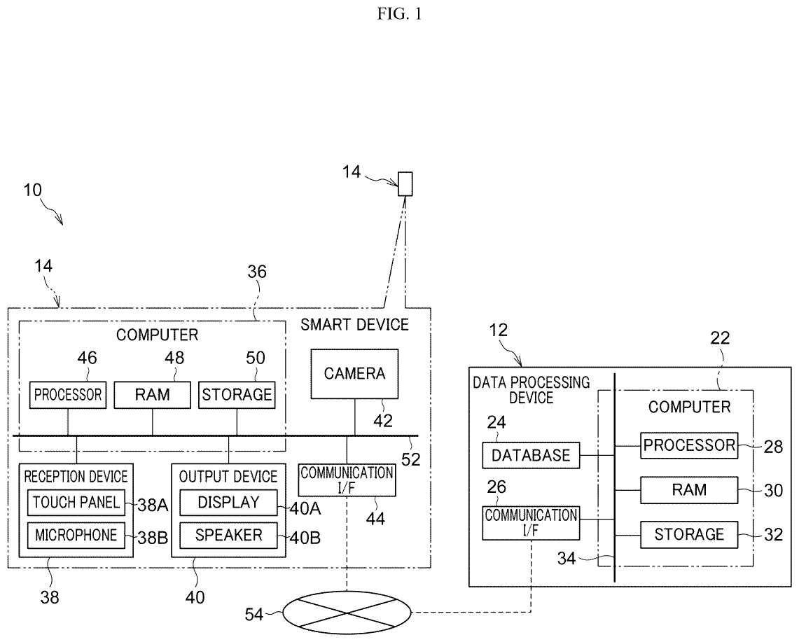

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

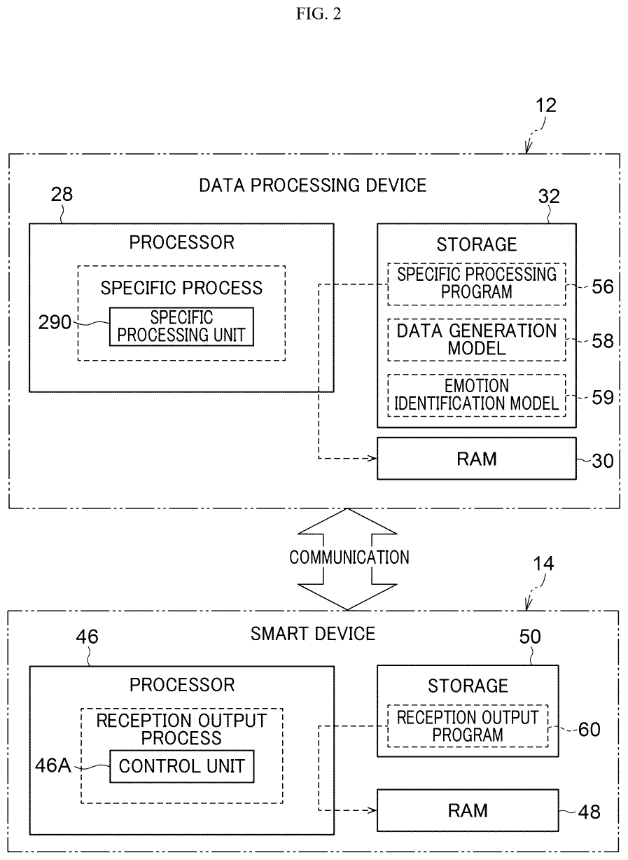

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional regulation management systems largely rely on manual drafting and editing of internal regulations in response to changes in laws and intra-organizational positions. In typical implementations, a user inputs law revision information or organizational change information into a document management tool or workflow tool, and human experts manually search existing regulations, draft amendment text, circulate the draft by email or a basic workflow engine, and then update a regulation repository. Such implementations suffer from several technical problems when deployed at scale in a networked computer environment.

First, conventional systems do not efficiently utilize machine-generated text in a structured, traceable manner. Although text generation technologies exist, typical integrations treat generated text as an unstructured attachment, without preserving the relationship between the input change information, the existing regulation data, and the generated draft amendment in a consistent, queryable data model. As a result, servers cannot reliably compute differences between versions, cannot automatically determine which records must be updated, and cannot maintain an auditable history of amendments at a fine-grained level. This leads to increased storage overhead due to redundant documents, higher processing load for repeated manual comparisons, and degraded performance when retrieving or reconstructing historical regulation states.

Second, conventional systems lack a tightly-coupled control flow between a generative AI model and an electronic workflow engine. In many cases, a user manually copies and pastes prompts into a separate generative AI interface, retrieves generated text, and then uploads or pastes the result back into a workflow tool. This fragmented flow prevents the server from programmatically generating standardized prompt sentences based on structured regulation data, prevents automatic association of generated drafts with particular approval tasks, and limits the ability to orchestrate re-prompting or iterative refinement when approvers request changes. Consequently, the overall process is susceptible to human error, inconsistent prompt formats, and non-repeatable system behavior, which in turn increases processing time and reduces the reliability of the computer system as a whole.

Third, many existing systems handle versioning of regulations in an ad hoc fashion, such as overwriting existing files or storing entire documents as new versions without structured metadata. Such approaches impose a heavy burden on database operations, because the system often must scan large, unstructured document blobs to reconstruct historical states or determine applicable regulations for a given time period. This can lead to inefficient query plans, increased I/O load, and delayed response times in a multi-user environment, particularly when regulations are frequently updated due to continuous legal changes or reorganizations.

Fourth, conventional systems offer limited machine-readable explanations of how a regulation applies in specific situations. While human experts may author separate guidelines or case examples, such content is often not systematically linked to the underlying regulation data or managed through a common workflow. As a result, servers cannot automatically generate or update application examples in a consistent manner when the base regulation text changes, which complicates maintenance of aligned explanatory content and impairs the usability of regulation search and presentation functions in the client terminals.

Accordingly, there is a need for an improved computer-implemented system that: (i) programmatically generates structured prompt sentences for a generative AI model based on stored regulation data and change information; (ii) receives and stores generated amendment text as structured amendment data; (iii) automatically computes and stores differences between the original regulation data and the amendment data; (iv) integrates this amendment data with an electronic workflow engine to create and manage approval tasks; and (v) maintains versioned regulation data and associated application examples in a time-series manner. By addressing these issues at the level of server-side data structures and control logic, the present invention aims to improve the technical functioning of regulation management systems, including database efficiency, workflow orchestration, traceability of AI-generated content, and quality of information presented to client terminals.

The specific processing by the specific processing unit 290 of the data processing device 12 in Example 1 is realized by the following means.

The present invention provides a server comprising a processor and a storage device, the processor being configured to receive input information including law change information or intra-organizational position information from a client terminal and store the input information in the storage device; to analyze the input information to extract, from regulation data stored in the storage device, regulation data to be revised; to generate a prompt sentence, based on an analysis result and the extracted regulation data, for instructing a generative AI model executed by an external information processing service to generate a draft amendment of a regulation; to transmit the prompt sentence to the external information processing service and receive regulation amendment text generated by the generative AI model; to store the received regulation amendment text as amendment data in the storage device and generate difference information between the amendment data and original regulation data; to generate, based on the amendment data and the difference information, approval task data for respective approvers and notify related terminals of the approval task data and the amendment data via an electronic workflow; to update a state of the amendment data based on approval information or modification information received from the related terminals and, when a predetermined approval condition is satisfied, update the regulation data in the storage device by adopting the amendment data as final regulation data; and to store, in the storage device, contents of the regulation data for each version and validity periods of the contents as history information in a time-series manner and, when the amendment data is adopted as the final regulation data, retain old-version regulation data as history data, and further to generate a prompt sentence for instructing the generative AI model to generate application example text relating to the regulation data and store the application example text as explanation data that is presentable to the related terminals. This enables the server to improve computer-implemented regulation management by structurally linking change information, regulation data, AI-generated amendment data, difference information, approval task data, and versioned history data, thereby reducing manual operations, improving database query performance, enhancing traceability and reproducibility of AI-assisted amendments, and providing consistently updated application examples to client terminals.

The term “processor” refers to a hardware or virtual computation unit, such as a central processing unit or a processing core in a virtualized environment, that executes instructions of a program to perform data processing operations described in this specification.

The term “storage device” refers to a hardware or virtual storage resource, such as a memory device or a non-volatile storage apparatus, that stores data including input information, regulation data, amendment data, history information, and explanation data in an electronically readable form.

The term “user terminal” refers to an information processing apparatus, such as a client computer, a mobile device, or a web-enabled terminal, operated by a user to transmit input information to the server and to receive and display amendment data, approval tasks, and explanation data.

The term “client terminal” refers to a user terminal that communicates with the server via a communication network in order to send requests and receive responses relating to regulation management processing.

The term “related terminal” refers to a user terminal associated with an approver or another stakeholder, which receives approval tasks and amendment data via an electronic workflow and transmits approval information or modification information to the server.

The term “input information” refers to electronic data received from a user terminal and including at least law change information or intra-organizational position information, and optionally additional metadata such as affected business areas, effective dates, and explanatory text.

The term “law change information” refers to data representing a change in a legal provision, such as an amendment, repeal, or addition of a law or regulation, including content describing the changed requirements and, optionally, effective dates or references to original legal sources.

The term “intra-organizational position information” refers to data representing a change in an organizational role or position within an entity, including creation, deletion, renaming, or reallocation of responsibilities of positions referenced in internal regulations.

The term “regulation data” refers to structured electronic data representing internal rules, policies, or procedures of an organization, including identifiers, text clauses, categories, and associated metadata stored in the storage device.

The term “regulation data to be revised” refers to regulation data that has been identified by the processor, based on analysis of input information, as being targeted for amendment or update.

The term “prompt sentence” refers to a text or machine-readable instruction sequence generated by the processor and supplied as an input to a generative AI model, the instruction sequence specifying at least a task relating to amendment of regulation data or generation of application example text.

The term “generative AI model” refers to a machine learning-based information processing model, such as a neural network-based language model, that generates output text or other content in response to an input prompt sentence.

The term “external information processing service” refers to a network-accessible computing service distinct from the server, which executes the generative AI model and returns generated text or related output to the server.

The term “regulation amendment text” refers to text generated by the generative AI model in response to a prompt sentence, the text representing a proposed amendment or replacement for at least part of existing regulation data.

The term “amendment data” refers to structured electronic data stored in the storage device and including regulation amendment text, associated identifiers, metadata, and status information relating to its approval or adoption.

The term “original regulation data” refers to regulation data stored prior to application of a corresponding amendment, the data serving as a basis for computing differences with amendment data.

The term “difference information” refers to data representing a comparison result between the amendment data and original regulation data, including at least identification of modified, added, or deleted portions.

The term “approval task data” refers to structured electronic data that defines work items assigned to approvers, including references to amendment data, required actions, status information, and, optionally, deadlines or priority levels.

The term “electronic workflow” refers to a computer-implemented control sequence and communication mechanism that routes approval task data, amendment data, and status updates among the server and related terminals.

The term “approval information” refers to data transmitted from a related terminal to the server and indicating that an approver has approved or rejected a particular amendment data or has completed a related approval task.

The term “modification information” refers to data transmitted from a related terminal to the server and indicating alterations made by an approver to amendment data, including edited text or annotations.

The term “predetermined approval condition” refers to at least one rule or set of rules defined in the system, which specifies the requirement under which amendment data is considered fully approved, such as completion of all assigned approval tasks with an approval status.

The term “final regulation data” refers to regulation data that has been updated in the storage device by adopting corresponding amendment data after satisfaction of a predetermined approval condition.

The term “version” refers to a state of regulation data at a particular point in time, distinguishable from other states of the same regulation data by content or validity period.

The term “validity period” refers to a time interval during which a particular version of regulation data is intended to be effective or applicable.

The term “history information” refers to data maintained in the storage device that associates versions of regulation data with their validity periods and change events in a time-series manner.

The term “history data” refers to stored regulation data that has been superseded by newer regulation data, but retained as part of the history information to allow reconstruction of past states.

The term “application example text” refers to text generated by the generative AI model that describes example situations, scenarios, or case applications illustrating how regulation data is to be applied.

The term “application situation information” refers to data, including application example text, that represents usage conditions, scenarios, or contexts in which a regulation is applicable.

The term “case information” refers to data representing a specific hypothetical or actual scenario used to illustrate application of a regulation, including factual conditions and resulting regulatory interpretation.

The term “explanation data” refers to structured data stored in the storage device that includes application example text or other descriptive content and is configured to be presented to related terminals as explanatory material for regulation data.

In one embodiment, a server cooperates with one or more terminals and a generative AI model executed by an external information processing service to manage internal regulation data in response to law change information and intra-organizational position information. The server includes a processor such as a central processing unit or a virtualized processing core, and a storage device such as a relational database and a non-volatile storage apparatus.

The server executes a regulation management program implemented, for example, using a server-side framework such as a general-purpose web framework written in a high-level programming language. The server runs on a computing platform such as a rack-mounted server or a virtual machine instance provided by a network-based computing environment. The storage device includes a relational database system such as a general-purpose SQL database (for example, a system equivalent to MySQL or PostgreSQL) deployed on the same machine or on a separate storage server. The server further uses a web server component such as an HTTP server (for example, a system equivalent to Apache HTTP Server or Nginx) to receive HTTP/HTTPS requests from terminals.

The terminal operates as a client device, such as a personal computer, a smartphone, or a tablet, executing a browser or a dedicated application. The terminal displays web pages built with technologies such as HTML, CSS, and JavaScript frameworks (for example, a framework equivalent to React or Vue.js). The user operates the terminal to input law change information or intra-organizational position information into the system. The user can also upload associated documents such as portable document files or word processing files that describe the legal changes or organizational modifications.

The server, upon receiving such input information, stores the information as structured records in the relational database. The storage device maintains tables including, for example, a revisions table, a regulations table, an amendment drafts table, an approval tasks table, and a regulation history table. The regulations table stores regulation data such as regulation identifiers, category codes, clause texts, effective dates, and relationship fields that link regulations to business domains or organizational units. The revisions table stores law change information and intra-organizational position information together with metadata such as effective dates, source document identifiers, and user identifiers.

The server analyzes the input information by using text-processing modules implemented in the regulation management program. The server can invoke a text extraction tool such as a general-purpose content extraction library (for example, a component equivalent to Apache Tika) to convert uploaded documents into plain text. The server normalizes character encodings to a unified format such as UTF-8, removes non-textual elements, and splits the text into logical segments based on headings or punctuation. The server then uses language-processing libraries (for example, components equivalent to spaCy, NLTK, or an in-house tokenizer) to detect key terms, legal concepts, and references to roles or positions within the organization.

The server maps detected terms to internal regulation categories by using mapping tables stored in the relational database. For example, the server associates the term “working hours” with a category code such as “LABOR_WORKING_HOURS,” and associates a position designation such as “Director of Human Resources” with an internal position code. The server executes structured queries on the regulations table, such as selecting all records whose category matches the detected category or whose text contains a stored position code. The server thus identifies regulation data to be revised in a deterministic and machine-readable manner, rather than relying on unstructured document scanning.

The server generates a prompt sentence for a generative AI model by combining the analyzed change information with the identified regulation data. The server constructs the prompt sentence using a predefined template stored in the storage device. The server inserts into the template: (i) a background description summarizing the law change information or intra-organizational position information, (ii) the current regulation text to be revised, and (iii) explicit instructions for the type and format of the desired output. For instance, the server can generate the following prompt sentence in plain text:
“A new law has reduced the monthly overtime limit from 60 hours to 45 hours. Below is our existing internal regulation on working hours. Please generate a revised version that complies with the new law, retains the original structure as much as possible, and uses clear, formal corporate language.

Existing regulation:

‘Employees may work overtime up to 60 hours per month with prior approval from their supervisor.’”

In another example, the server generates a prompt sentence relating to organizational position changes such as:
“Our internal regulations currently refer to the position name ‘Director of Human Resources.’
Background: This position has been renamed to ‘Chief People Officer’ without changing substantive responsibilities.
Existing regulation clauses:
1. ‘The Director of Human Resources shall approve all hiring decisions.’
2. ‘Any changes to the personnel evaluation system shall be authorized by the Director of Human Resources.’
Task: Please propose revised versions of these clauses in which ‘Director of Human Resources’ is consistently replaced with ‘Chief People Officer,’ ensuring that the meaning and scope of responsibility remain the same and that the style remains formal and consistent.”

The server generatively adjusts the prompt sentence by measuring its length, tokenizing the text, and truncating or summarizing long segments to satisfy a predetermined token limit. In one embodiment, the server estimates token counts using a tokenization algorithm similar to byte-pair encoding (BPE) or a unigram language model tokenization used by the external generative AI model. By performing such token control at the server side, the system avoids failed requests due to excessive prompt length and reduces communication bandwidth.

The generative AI model runs on the external information processing service. The generative AI model can be implemented as a transformer-based neural network with multiple self-attention layers, feedforward layers, and residual connections. In one embodiment, the generative AI model uses an architecture with an encoder-decoder or decoder-only configuration, a vocabulary built from sub-word tokens, and learned embedding matrices for token and positional information. The generative AI model processes the prompt sentence by converting it into a sequence of token embeddings, applying multi-head self-attention to compute contextualized representations, and generating output token probabilities based on a softmax function at each decoding step.

The generative AI model has been pre-trained on large-scale text corpora using an unsupervised learning objective such as next-token prediction or masked language modeling. During pre-training, the generative AI model minimizes a loss function such as cross-entropy between predicted token distributions and ground-truth tokens, and updates its parameters by backpropagation and an optimization algorithm such as Adam. In some implementations, the generative AI model may be fine-tuned on domain-specific data related to legal texts or organizational policies using supervised learning or reinforcement learning with human feedback. Such training steps cause the neural network to internalize patterns of legal phrasing, regulatory structure, and drafting conventions that cannot be readily encoded using simple rule-based systems.

The server transmits the generated prompt sentence to the external information processing service via a secure communication protocol such as HTTPS. The server includes in the request information such as the model identifier, decoding parameters (for example, temperature, top-k, or top-p), and a maximum token count for the output. The external information processing service executes the generative AI model on hardware accelerators such as graphics processing units or tensor processing units, and returns a response containing regulation amendment text generated by the model.

The server receives the regulation amendment text and stores it as amendment data in the amendment drafts table. The server computes difference information between the amendment data and the original regulation data by using a text differencing algorithm such as a line-based or word-based diff. The server represents the difference information as structured data, for example, including lists of inserted segments, deleted segments, and modified segments, together with positional indices. By storing the difference information separately from the full text, the server can display highlighted changes on the terminal while minimizing data transfers and enabling efficient reconstruction of past versions based on stored operations.

The server generates approval task data that associates the amendment data with designated approvers. The server records for each approval task data a reference to the amendment draft identifier, an approver identifier, a current status, and optional constraints such as expiration dates or escalation rules. The server controls an electronic workflow engine that dispatches notifications to related terminals via email or push messages and provides URLs or identifiers to access the pending tasks. The workflow engine may be implemented as part of the regulation management program or by integration with an external workflow management system.

The terminal displays, to an approver, the original regulation text, the amendment text, and the difference information. The terminal uses graphical highlighting such as color changes or underlines to indicate additions and deletions. The user, acting as an approver, can modify the amendment text in a rich text editor and can enter comments or reasoning for the decision. The terminal transmits approval information or modification information back to the server. The server updates the corresponding approval task data and amendment data with the received information.

When the amendment data does not satisfy the approver's requirements, the server may generate a new prompt sentence that includes the previous amendment text and the approver's comments. For example, the server may construct:
“Here is a draft regulation text proposed earlier:
[previous draft text]
Here are the reviewer's comments:
[reviewer comments]

Please provide a revised version that addresses these comments while maintaining legal compliance and clarity.”

The server sends this prompt sentence to the generative AI model and stores the newly generated amendment text as a subsequent draft. This iterative loop allows the server to coordinate complex amendment refinement steps without manual copy-and-paste operations and ensures that each revision is linked to prior drafts and feedback in a structured manner.

When a predetermined approval condition is satisfied (for instance, when all required approvers have set their tasks to an approved state), the server updates the regulations table by copying the amendment text into the regulation data record as final regulation data. The server archives the previous regulation text into the regulation history table, associating it with a version identifier and a validity period. Because the server stores regulation data at the level of individual clauses or fields rather than monolithic documents, the server can respond to queries such as “what text was effective on a given date” or “which clauses changed in a designated revision” by executing highly selective queries. This structure enhances database performance, reduces I/O overhead, and simplifies maintenance of an audit trail.

In another embodiment, the server uses the generative AI model to generate application example text. The server composes a prompt sentence instructing the generative AI model to create scenario-based explanations for how a particular regulation applies in practice. For example, the server may generate:
“below Is an Internal Regulation Concerning Working Hours.
Regulation text:
‘Employees may work overtime up to 45 hours per month with prior approval from their supervisor, and overtime beyond 30 hours requires written justification.’
Task: Please provide three clear and realistic example scenarios that illustrate how this regulation is applied in practice, including whether overtime is permitted and what approvals are required.”

The generative AI model generates application example text, and the server stores this application example text as explanation data linked to the corresponding regulation record. The terminal then presents the explanation data to general users who need to understand how the regulations operate, without requiring human experts to manually maintain separate guidance documents.

The server, by controlling data structures such as amendment drafts, difference information, approval tasks, and regulation history, accomplishes technical improvements beyond mere automation of human drafting. Specifically, the server reduces redundant storage by separating and indexing shared regulation data and storing only differences for each amendment. The server improves query performance by using normalized relational tables and index structures that permit rapid retrieval of regulation versions by date, category, or organizational unit. The server reduces communication bandwidth between the server and terminals by transmitting compact difference information instead of entire documents for viewing changes.

The cooperation between the server and the generative AI model also improves computational efficiency. The server automatically adjusts prompt length and content composition based on tokenization rules that mirror the model's tokenizer, thus minimizing failed requests and unnecessary retries. The server standardizes prompt structure across all amendments, which leads to more predictable outputs from the generative AI model and reduces the need for post-processing corrections. The server further enforces domain-specific constraints on the generated text by embedding rule-based checks and regular expression filters that detect unwanted patterns, ensuring that only technically valid amendment candidates proceed to the approval stage. These constraints constitute a non-conventional combination of machine-learned text generation with deterministic rule-based validation.

The generative AI model itself uses a neural network architecture and training procedures that depart from conventional, purely manual editing workflows. The model learns high-dimensional representations of legal phrasing and regulatory logic and uses them to produce syntactically and semantically coherent amendment suggestions that respect domain conventions. During inference, the model applies attention mechanisms across all tokens in the prompt sentence, enabling the model to align parts of the legal change description with specific segments of the existing regulation text. This internal alignment is exploited by the server-side differencing and versioning structures to pinpoint changes at a granular level, achieving reduced error rates in identifying which parts of the regulation must be updated.

Because the server performs tightly integrated operations—prompt construction, structured storage of amendment data, computed difference information, workflow-based approval control, and time-series history maintenance—the system achieves technical effects such as reduced processing time for large regulation sets, improved accuracy in applying legal changes, more efficient use of network and storage resources, and enhanced traceability of how and why certain regulation texts were changed. These improvements arise from the particular arrangement of modules and data structures and from the specific interaction pattern between the server and the generative AI model, rather than from generic use of computers for document editing.

Alternative embodiments are also possible. In one variation, the server executes multiple generative AI models with different sizes or training specializations and selects a model based on regulation category or required output length. In another variation, the server supplements the generative AI model with a rule-based engine that encodes critical legal thresholds or prohibited terms, and automatically flags any generated amendment text that conflicts with these rules. In yet another variation, the server runs the generative AI model locally on dedicated hardware accelerators within an on-premises environment, thereby improving latency and enabling operation without external network dependencies. In each of these embodiments, the fundamental structure remains: the server generates structured prompt sentences from stored regulation data and change information, receives generated amendment or application example text, stores the text as structured data, computes and retains difference information, controls approval workflows, and updates versioned regulation data in a way that enhances the technical performance of the underlying computing system.

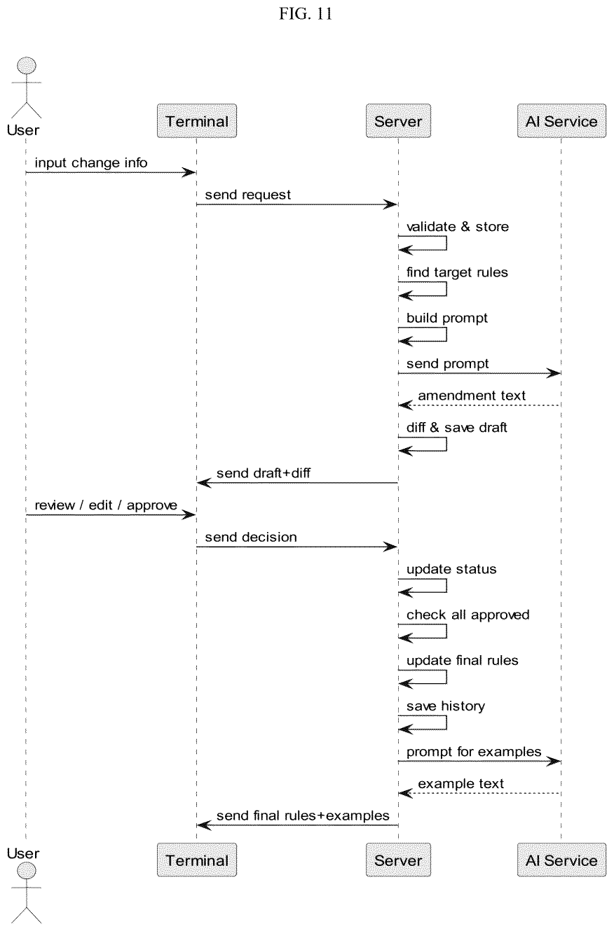

The following describes the processing flow using FIG. 11.

### Step 1:

User operates the terminal to input law change information or intra-organizational position information and optionally upload related documents.

Terminal receives text fields (such as law name, summary of change, effective date, affected positions) and file data (such as PDFs), and packages them into an HTTPS request.

Terminal sends the request, including authentication information, as input to the server.

Server receives this input and parses the HTTP headers, the JSON body, and the multipart-form data to extract structured text fields and binary file streams as output data structures for further processing.

### Step 2:

Server validates the received input information and normalizes it.

Server takes as input the parsed text fields and file metadata, checks required fields, validates formats (for example, date formats, string length), and rejects incomplete or invalid records.

Server, when validation succeeds, converts character encodings to a unified format (for example, UTF-8) and trims unnecessary whitespace or control characters.

Server outputs cleaned input records and validated file references, and returns error responses to the terminal when validation fails.

### Step 3:

Server stores the validated input information in the storage device as structured records.

Server takes as input the cleaned text data and file references, and issues SQL INSERT statements via an ORM to populate tables such as a revisions table and an uploaded_documents table.

Server writes fields including change type, description, effective date, and user ID into the revisions table, and stores file paths or object storage URLs in the uploaded_documents table.

Server outputs persistent identifiers (for example, revision IDs and document IDs) that uniquely reference the stored records.

### Step 4:

Server extracts raw text from uploaded documents and preprocesses it.

Server uses the document IDs and file paths as input, and invokes a text extraction component to read the binary file data and convert it into plain text.

Server removes non-text elements, normalizes line breaks, and splits the text into logical segments using punctuation and heading patterns.

Server stores the processed text as output in a field such as an extracted_text column of the revisions table, linked to the corresponding revision ID.

### Step 5:

Server identifies regulation data to be revised based on the change information.

Server takes as input the change description text and the extracted_text associated with the revision ID and applies keyword matching, regular expressions, and optional NLP-based entity recognition to detect legal topics and position names.

Server queries the regulations table using the detected topics and position identifiers, executing SELECT statements that filter by category, text content, or referenced position codes.

Server outputs a list of target regulation records, each including a regulation ID, current text, category, and metadata indicating that they are candidates for amendment.

### Step 6:

Server constructs a structured prompt sentence for the generative AI model.

Server takes as input the target regulation records and the revision data (law change information or intra-organizational position information) and inserts these values into a template stored in the storage device.

Server concatenates a background section, the existing regulation text, and explicit instructions describing the desired amendment style and constraints, and then tokenizes the resulting string to estimate token length.

Server, when necessary, truncates or summarizes segments to remain within a token limit and outputs a finalized prompt sentence ready to be sent to the generative AI model.

### Step 7:

Server sends the prompt sentence to the external information processing service and receives generated amendment text.

Server takes as input the finalized prompt sentence and communication parameters (model ID, maximum output tokens, decoding parameters) and constructs a JSON payload for an HTTPS POST request.

Server transmits the payload to the generative AI API endpoint and, upon receiving the response, parses the JSON to extract the amendment text generated by the generative AI model and associated metadata such as token usage.

Server outputs the generated amendment text and model metadata as structured data objects for storage and further analysis.

### Step 8:

Server stores the generated amendment text as amendment data and computes difference information.

Server takes as input the amendment text and the original regulation text and writes the amendment text into an amendment_drafts table with a new draft ID and a status field initialized to a pending state.

Server calls a text differencing function that compares the original and amended texts line by line or token by token, identifies inserted, deleted, and modified segments, and assigns position indices to each change.

Server stores the resulting difference information in a table such as a regulation_diffs table, and outputs a combined dataset linking the draft ID, the original regulation ID, and the difference details.

### Step 9:

Server generates approval task data and initiates an electronic workflow.

Server uses as input the amendment draft ID, the associated regulation ID, and predefined approval rules that specify which roles or departments must review each category of regulation.

Server creates approval_tasks records for each required approver, setting fields such as assignee ID, draft ID, task status, creation time, and deadline.

Server outputs notification messages and workflow events to be delivered to related terminals, including URLs or identifiers that allow approvers to access the amendment draft and difference information.

### Step 10:

Terminal receives workflow notifications and displays amendment details to approvers.

Terminal takes as input a notification (for example, from email or a push message) that contains a link or an identifier, and sends a request to the server to retrieve the corresponding draft and difference information.

Terminal receives JSON or HTML containing the original text, the amendment text, and change markers, and renders them in a user interface with visual highlighting and editable text fields.

Terminal outputs an interactive screen that allows the user to view, edit, and comment on the amendment draft.

### Step 11:

User reviews the amendment draft and provides approval information or modification information.

User operates the terminal to read the displayed texts, make edits in a rich text editor if necessary, and select an action such as approve or reject.

Terminal collects the updated amendment text (if any), the decision status, and optional comments as input, and sends these elements in an HTTPS request back to the server.

Terminal outputs a decision payload that includes approver identity, task ID, edited text, and decision flags.

### Step 12:

Server updates approval task status and amendment data according to approver input.

Server takes as input the decision payload, locates the corresponding approval_tasks record, and updates its status field to approved, rejected, or needs revision.

Server, when modified text is included, stores the modified text either as a new version of amendment data or as a manual_edited_text field associated with the existing draft ID.

Server outputs updated approval status and amendment data records, and evaluates whether all required approvals have been obtained.

### Step 13:

Server optionally constructs a revised prompt sentence for iterative amendment generation.

Server uses as input the previous amendment text, the approver's comments, and any specified objections or required changes, and combines them into a new prompt template.

Server generates a prompt sentence that explicitly includes the original draft, the critique, and constraints for revision, and again performs token-length adjustment.

Server outputs this revised prompt sentence to be sent to the generative AI model for a new round of amendment text generation, following the same transmission and storage operations as in earlier steps.

### Step 14:

Server finalizes the amendment and updates regulation data when predetermined approval conditions are satisfied.

Server takes as input the collection of approval task statuses associated with a given draft ID and evaluates a rule such as “all approvers must approve” or “a designated majority must approve.”

Server, upon determining that the condition is met, copies the amendment text from the amendment_drafts table into the regulations table as final regulation data and sets an effective date and version identifier.

Server outputs an updated regulation record and, concurrently, copies the superseded regulation text into the regulation_history table as history data with a recorded validity period.

### Step 15:

Server generates application example text and stores it as explanation data.

Server takes as input the finalized regulation text and optional parameters indicating the number and type of examples desired, and constructs a prompt sentence instructing the generative AI model to generate application example text.

Server sends this prompt to the external information processing service, receives example scenarios, and stores them as explanation data in a table such as regulation_explanations, linked to the regulation ID.

Server outputs structured explanation records that can be retrieved by terminals for user guidance.

### Step 16:

Terminal retrieves final regulation data and explanation data for general users.

Terminal takes as input user requests specifying a regulation category, ID, or search keyword, and sends a query to the server.

Terminal receives from the server the current version of the regulation text and any associated application example text, and renders them in a readable format on the display.

Terminal outputs screens that allow users to browse, search, and understand regulations with up-to-date texts and examples.

### Step 17:

User views and utilizes the final regulation data and explanation data.

User operates the terminal to read the displayed regulations and application examples, search for specific clauses, and reference the content for operational or compliance decisions.

User, based on the presented information, may perform actions in the real-world environment such as adjusting internal procedures or configuring other systems according to the updated regulations.

User outputs no additional electronic data in this step unless further feedback or inquiries are submitted, but consumes the server's outputs as guidance for subsequent processes.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional governance and compliance management systems rely heavily on manual interpretation of law revisions and organizational role changes, and on manual drafting and distribution of regulation amendments. In such systems, human operators must periodically monitor legal information sources and personnel information sources, read and interpret complex natural-language texts, identify affected internal regulations, and then manually draft amendment proposals in a word processor or similar application. These operators must also manually initiate approval workflows, track approval status, update regulation repositories, and notify stakeholders. This workflow is time-consuming, error-prone, and difficult to scale as the volume and frequency of regulatory changes increase.

From the viewpoint of computer technology, such conventional approaches underutilize the capabilities of information processing resources. The systems mainly function as passive storage and messaging platforms, while the core tasks of text analysis, impact detection, amendment drafting, and explanatory content generation are performed outside the system by human experts. As a result, (i) the latency between an external change (for example, a new law or a role restructuring) and the internal system state update is large, (ii) the internal data structures of regulations and amendments are not consistently aligned with the external information, and (iii) the logs necessary to reconstruct how a particular regulation version was derived are fragmented or missing. This leads to weak traceability, low automation, and limited ability of the system to provide timely, context-aware answers to user queries.

In addition, in conventional systems, when a user submits a question regarding a specific regulation or policy, the system typically performs only simple keyword search or document retrieval. The user must manually read long and complex regulation documents to understand the applicable rules. The system does not compute a semantic mapping between the user's natural-language question and the internal regulation corpus, and does not generate tailored explanations. This imposes a cognitive burden on users and limits the effectiveness of the system as a decision-support tool.

Further, existing systems generally do not provide a unified, machine-processable audit trail that connects (i) the external legal and personnel information that triggered a change, (ii) the internal prompt sentences provided to automated text generation components, (iii) the outputs of those components, and (iv) the final adopted regulation versions and notifications. Without such an integrated log at the system level, it is difficult to verify or reproduce how a particular regulation text was generated, and difficult to leverage historical data to improve system behavior.

Thus, there is a need for a computer-implemented technique that transforms the regulation management workflow into an integrated, automated information processing pipeline. In particular, there is a need for a system-level mechanism in which a processor can: (a) automatically acquire and structurally analyze external legal and personnel information, (b) generate prompt sentences that guide a generative AI model, (c) automatically obtain draft amendments and explanatory texts from the generative AI model, (d) integrate these drafts with an electronic workflow mechanism and a regulation repository, (e) maintain versioned formal regulation information and associated log information, and (f) respond to user queries with dynamically generated explanations and application examples. By structuring these operations as explicit computational steps performed by the processor, the overall functioning of the compliance management system as a computer technology can be improved, including improvements in processing efficiency, automation level, traceability, and responsiveness to user queries.

The specific processing by the specific processing unit 290 of the data processing device 12 in Application Example 1 is realized by the following means.

The present invention provides a server comprising a processor configured to (i) perform communication processing with an external information source including a legal information source and a personnel information source to automatically acquire external document data including law revision information and role change information, (ii) execute a language processing program on the external document data to perform phrase extraction processing and structural analysis processing so as to extract regulation-related elements into structured internal data, (iii) generate, on the basis of the extracted elements and internal regulation information stored in a storage medium, a prompt sentence that instructs generation of a draft regulation amendment, (iv) invoke a generative AI model using the prompt sentence as input and cause the generative AI model to generate amendment document data, (v) register the amendment document data in an electronic workflow mechanism and control transmission of approval requests and receipt of approval results through the electronic workflow mechanism, (vi) in response to approval results, store approved amendment document data as formal regulation information in the storage medium in association with validity period information and perform version management of the formal regulation information, (vii) generate notification information including update details of the formal regulation information and control transmission of the notification information to a terminal device, (viii) acquire, from the terminal device, a user question sentence related to regulation content, execute the language processing program on the user question sentence to extract topic information, search the internal regulation information for regulation document data related to the topic information, and generate, on the basis of the user question sentence and the regulation document data, a prompt sentence that instructs explanation of the regulation content, (ix) invoke the generative AI model using the prompt sentence for explanation to generate explanation document data and control presentation of the explanation document data on the terminal device, and (x) store, as log information, the prompt sentences and the amendment document data or the explanation document data output from the generative AI model in association with corresponding external information, internal regulation information, approval result information, and notification information in a searchable format. This enables the regulation management system itself to perform, as a unified series of computer-implemented operations, automated acquisition and analysis of external change information, structured prompt sentence generation, controlled invocation of a generative AI model, workflow-integrated amendment generation and adoption, version-controlled storage of formal regulation information, context-aware response to user queries, and comprehensive logging, thereby improving processing efficiency, reducing manual intervention, enhancing traceability, and increasing the responsiveness and reliability of the computer-based governance and compliance infrastructure.

The term “external information source” refers to an information providing entity or system, such as a legal information system or a personnel information system, that supplies document data including law revision information and role change information to the server via a communication network.

The term “legal information source” refers to an external information source that provides document data representing laws, regulations, standards, guidelines, or other legal or regulatory texts, including revisions or amendments thereto.

The term “personnel information source” refers to an external information source that provides document data representing organizational personnel data, including information on roles, job titles, assignments, or changes of such roles within an organization.

The term “external information” refers to information obtained from an external information source, including but not limited to law revision information and role change information, represented as document data.

The term “law revision information” refers to information indicating creation, modification, or repeal of a law, regulation, standard, or guideline, including additions, deletions, or changes to clauses, articles, or provisions.

The term “role change information” refers to information indicating the creation, modification, assignment, or removal of organizational roles, job titles, or responsibilities, and changes in association between such roles and specific persons or organizational units.

The term “document data” refers to data representing human-readable content, including but not limited to text describing laws, regulations, personnel records, regulations, or explanations, in a structured or unstructured form.

The term “regulation revision” refers to a change in internal regulation information, including changes to wording, structure, scope, or applicability of one or more internal rules or policies.

The term “language processing program” refers to software that performs natural language processing on document data, including operations such as tokenization, phrase extraction, part-of-speech tagging, entity recognition, or structural analysis.

The term “phrase extraction processing” refers to a process in which the language processing program identifies and extracts particular words, phrases, or expressions from document data based on linguistic rules or statistical models.

The term “structural analysis processing” refers to a process in which the language processing program analyzes syntactic or semantic structures of document data, including relationships between words, phrases, sentences, or sections, to organize the data into structured internal data.

The term “regulation-related elements” refers to elements extracted from document data that are relevant to internal regulations, including but not limited to defined terms, obligations, prohibitions, conditions, roles, effective dates, and references to external legal bases.

The term “internal regulation information” refers to information representing internal rules, policies, procedures, or guidelines of an organization, stored in a storage medium in a form suitable for retrieval, processing, and update by the server.

The term “storage medium” refers to a physical or logical storage resource, such as a memory device or a persistent storage device, configured to store internal regulation information, external information, amendment document data, explanation document data, or log information.

The term “prompt sentence” refers to a text sequence generated by the processor that instructs a generative AI model to perform a specified generation task, including generation of a draft regulation amendment, an explanation document, or an application example.

The term “generative AI model” refers to an information processing model implemented by a computing system and configured to generate new text or other content in response to an input prompt sentence, based on machine learning or statistical modeling techniques.

The term “information processing model” refers to a computational model, including a generative AI model, that receives input data and produces output data as a result of executing one or more information processing algorithms.

The term “draft regulation amendment” refers to proposed changes to internal regulation information, represented as text or structured data, that have not yet been formally approved as a final regulation.

The term “amendment document data” refers to document data generated by the generative AI model or by the processor that describes a draft regulation amendment or an approved amendment in textual or structured form.

The term “electronic workflow mechanism” refers to a software-implemented control flow system that manages approval processing, including creation, assignment, tracking, and completion of approval tasks related to amendment document data.

The term “approval processing” refers to a series of operations in which one or more approvers review amendment document data and provide approval, rejection, or comments, and in which the system records and aggregates such decisions.

The term “approver” refers to a user or role that is authorized by the system to review and approve or reject amendment document data within the electronic workflow mechanism.

The term “approval result” refers to information representing a decision made by an approver with respect to amendment document data, including approval, rejection, or request for modification, and any associated metadata such as time and comments.

The term “formal regulation information” refers to internal regulation information that has been approved through the electronic workflow mechanism and is adopted as an official, effective version of a regulation or policy.

The term “validity period information” refers to information indicating a time period during which particular formal regulation information is in effect, including a start date, end date, or both.

The term “version management” refers to a process of storing, indexing, and controlling multiple versions of regulation information, including maintaining relationships between past and current versions and their validity periods.

The term “notification information” refers to information generated by the processor for the purpose of informing users or terminal devices of updates to formal regulation information, including summaries of changes and links to full texts.

The term “terminal device” refers to an information processing device operated by a user, such as a client computer, a mobile device, or a display apparatus, that communicates with the server to send input information and receive output information.

The term “question sentence” refers to a natural-language text input by a user via a terminal device, asking about content, interpretation, or application of internal regulation information.

The term “topic information” refers to information indicating the main subject matter, entities, or concepts extracted from a question sentence or document data by the language processing program.

The term “regulation document data” refers to document data that represents one or more portions of internal regulation information, such as clauses, sections, or articles, retrieved in response to a search or processing operation.

The term “explanation document data” refers to document data generated by the generative AI model or by the processor that provides a natural-language explanation, summary, or clarification of regulation content.

The term “application example document data” refers to document data generated by the generative AI model or by the processor that describes example scenarios of how a regulation applies in practical situations.

The term “log information” refers to information stored by the server that records processing histories, including prompt sentences, outputs of the generative AI model, associated external information, internal regulation information, approval results, and notification information.

The term “searchable format” refers to a data format and storage structure that allows the log information to be queried and retrieved based on one or more search keys, such as timestamps, identifiers, text content, or attribute values.

The term “user” refers to a person or entity that interacts with the system via a terminal device, including approvers, administrators, and ordinary staff members who submit questions or view regulation information.

In one embodiment, a server implements the claimed system by executing computer programs on general-purpose computer hardware. The server includes one or more processors, a main memory, a non-volatile storage device, a network interface, and an operating system such as a server-class operating system. The server is connected via a communication network such as the Internet or an intranet to one or more terminal devices operated by users. Each terminal device includes a processor, a memory, a display unit, an input unit, and a network interface, and executes a client program such as a web browser or a native application.

The server executes application software implemented, for example, in a high-level programming language running on a runtime environment. The application software includes multiple modules: a communication module for acquiring external information, a natural language processing module, a regulation management module, a workflow integration module, a generative AI integration module, a logging module, and a user interface backend module. The modules interact through explicitly defined data structures stored in a relational database system such as a structured query database, and in an indexed full-text search system.

The server uses a storage medium such as a disk array or solid-state storage to persist internal regulation information, external information, amendment document data, explanation document data, application example document data, and log information. The internal regulation information is stored in a structured form, for example as records in tables representing regulations, sections, clauses, and versions, each identified by primary keys and connected via foreign keys. The external information is stored as records linking source identifiers, timestamps, and normalized text of legal and personnel documents.

The server acquires external information by connecting, via the network interface, to external information sources including at least one legal information system and at least one personnel information system. The server uses a communication protocol such as HTTPS and a client library to send requests and receive responses in formats such as JSON or XML. The server converts the received responses into an internal canonical representation, for example by mapping JSON fields to internal fields such as “external_source_id,” “document_type,” “effective_date,” and “raw_text.” The server writes these internal representations into the database with transactional guarantees, ensuring consistency for later processing.

The server executes a language processing program that implements natural language processing algorithms using, for example, a pipeline consisting of tokenization, sentence boundary detection, part-of-speech tagging, morphological analysis, dependency parsing, and named entity recognition. In one embodiment, the server loads a statistical or neural-linguistic model trained on legal and organizational text data. The language processing program accepts as input a document string from external information or internal regulation information and outputs a structured representation that includes tokens, lemmas, part-of-speech tags, syntactic dependencies, and identified entities (such as law names, article numbers, roles, dates, and obligations).

The server uses the output of the language processing program to extract regulation-related elements. For example, the server builds a feature vector for each sentence, including term frequency-inverse document frequency values, dependency labels, and entity types. The server applies rule-based filters implemented as deterministic finite-state procedures combined with threshold-based evaluators to select sentences and clauses that contain indicators of obligations, prohibitions, conditions, or role assignments. The regulation-related elements are persisted as structured data, for instance in a normalized table containing fields such as “element_type,” “trigger_token,” “associated_role,” and “affected_clause_reference.”

The server maintains internal regulation information as a set of regulation records for an organization. Each regulation record is divided into sections and clauses, with associated metadata such as titles, effective periods, and related external legal bases. The server uses indexing structures, such as inverted indexes, to accelerate retrieval of clauses that reference specific legal sources, roles, or concepts. This structured representation allows the server to quickly compute which internal clauses are potentially impacted when new law revision information or role change information is acquired, thus improving processing speed and reducing computational overhead compared to scanning entire documents in a naive manner.

The server generates a prompt sentence for a generative AI model by combining the regulation-related elements extracted from external information with relevant internal regulation information. The prompt sentence is constructed as a text sequence according to a defined template that includes labeled sections such as “Instruction,” “New Legal Text,” and “Current Internal Regulation.” The server dynamically populates these sections by inserting text segments retrieved from the database. For example, the server can generate the following prompt sentence: “Based on the following new data protection regulation text and our current internal data protection policy, draft an amendment that updates the internal policy to comply with the new requirements. New regulation text: ‘[insert legal text]’. Current policy: ‘[insert internal policy text]’. Output a revised policy section in clear and formal language, preserving existing structure where possible.”

The prompt construction process uses specific rules to ensure that the total token count remains below a configured maximum, for example by summarizing long sections using the language processing program or by omitting non-relevant clauses determined via a relevance scoring function. This relevance scoring function can be implemented as a weighted sum of lexical overlap, semantic similarity based on word embeddings, and entity overlap between external and internal texts. Such handling of context length and relevance is a non-conventional computer-implemented technique that reduces network traffic and computational load on the generative AI model endpoint, thereby improving system performance.

The server invokes a generative AI model implemented as a neural network, for example a transformer-based language model. The generative AI model includes multiple layers of self-attention and feed-forward networks, with learned parameters that map token sequences to probabilities over vocabulary tokens. The model has been pre-trained on large-scale text corpora and optionally fine-tuned on domain-specific legal and policy texts. During operation, the server sends the prompt sentence as a tokenized text sequence to the generative AI model via an application programming interface. The model processes the sequence using attention mechanisms that compute attention scores between tokens and propagate contextual information through its layers. The model outputs a sequence of tokens representing the amendment document data or explanation document data.

The generative AI model is trained using a supervised or self-supervised learning method, such as minimizing a cross-entropy loss function between predicted token distributions and actual next tokens in training data. During training, model parameters are updated using stochastic gradient descent or a variant such as Adam, based on gradients computed via backpropagation. Data augmentation techniques may include mixing generic legal texts with organization-specific policy texts, anonymizing sensitive identifiers, and adding paraphrased training pairs to improve robustness. These training and architecture details show that the model is not a generic black box but a specific computational structure that improves the accuracy of generated regulation content compared to rule-based or template-based generators.

The server applies additional post-processing rules to the output of the generative AI model. The server splits the generated text into sentences, aligns them with existing clauses using similarity measures, and marks changed segments. For example, the server can compute a textual similarity score between generated clauses and existing clauses using cosine similarity over vector embeddings. The server then flags segments with similarity below a threshold as new or significantly modified text. This allows the workflow mechanism to highlight differences more effectively, reducing human review time and lowering the risk of oversight. Since this alignment is computed algorithmically, the server can scale to large volumes of amendments without linear increases in human workload, thus providing a technical effect beyond mere automation.

The server integrates with an electronic workflow mechanism that may be implemented as an internal web application or as an external workflow service. The server creates workflow items, sets approver lists based on role definitions stored in the database, and updates statuses in response to approver actions. The workflow items include pointers to amendment document data stored in the regulation repository. The server also generates notification messages such as email texts or in-app notifications that summarize the proposed changes and include links or identifiers to open the full draft. The terminal displays these notifications in a graphical user interface and allows approvers to open, review, and provide their decisions on amendment document data.

The terminal operates as a client that communicates with the server over a secure communication channel. The terminal displays regulation texts, amendment drafts, and explanations using layout and highlighting rules received from the server. The terminal sends user inputs, such as approvals, rejections, comments, and questions, as structured messages including user identifiers, timestamps, and context identifiers. The server validates these messages, checks user roles, and updates internal state accordingly. This interaction pattern provides a concrete mechanism for controlling the flow of amendment document data and explanation document data between server and terminal, satisfying practical technological requirements and decreasing the likelihood of inconsistent data states.

The server adopts approved amendment document data as formal regulation information. To do so, the server writes a new record in a version table that references the regulation, sets an effective start date, and links to the previous version as a predecessor. The server also writes an end date for the previous version and updates search indexes. This version management procedure enables efficient retrieval of the correct regulation text for a given date and improves accuracy when answering user queries about historical or future-effective rules. Because the system maintains explicit version chains and validity periods in structured form, queries can be answered programmatically using index lookups and date comparisons, which is a concrete improvement over ad hoc manual tracking.

The server generates notification information that includes structured fields such as “regulation_identifier,” “change_summary,” “effective_date,” and “impact_scope.” The server then formats this information into user-facing messages and sends them to terminal devices using a messaging protocol. For example, the server can send the following notification text:
“The internal data protection policy has been updated to reflect new legal requirements for encryption of personal data at rest and in transit. The updated policy takes effect on [date]. Please review section [section number] for details.”

The user receives and reads the notification on the terminal. The terminal can provide interfaces that allow the user to acknowledge reading the policy. The server stores such acknowledgments, enabling management of compliance-read status as part of the log information.

The server supports user queries about regulation content. The user inputs a question into a query interface on the terminal, such as:
“What rules apply to using personal data on a personal laptop when working remotely?”

The terminal sends this question sentence to the server. The server executes the language processing program on the question sentence, extracting topic information such as “personal data,” “personal laptop,” and “remote work.” The server uses this topic information to query the regulation repository and a full-text index. The server retrieves relevant regulation document data, such as clauses related to “remote access,” “use of personal devices,” and “handling of personal data.”

The server constructs a prompt sentence that instructs the generative AI model to generate an explanation. For example, the server can use a template:
“The following is our organization's data protection policy: ‘[insert policy text]’. A user has asked: ‘[insert user question]’. Explain which rules apply to the user's situation in clear, non-legal language, and provide concrete examples for employees. Do not change the meaning of the policy, and reference specific section numbers where relevant.”

The server invokes the generative AI model with this prompt sentence and obtains explanation document data. The explanation document data includes an answer tailored to the user's question, with references to relevant clauses and examples. The server may apply formatting rules, such as adding headings or bullet lists, and sends the explanation document data to the terminal. The terminal presents the explanation on the display, allowing the user to quickly understand applicable rules without manually searching and interpreting long documents.

The server maintains log information capturing each prompt sentence and corresponding outputs. When a prompt sentence is generated, the server creates a log record that includes the prompt text, associated external information identifiers, internal regulation identifiers, user identifiers (if applicable), timestamps, and processing context. When the generative AI model returns amendment document data or explanation document data, the server appends the output to the log record. The log information is stored in a searchable format, such as a structured document store indexed by prompt identifiers, timestamps, and content keywords. This allows later audit and analysis of how a particular regulation version or explanation was produced. From a technical perspective, this integrated logging schema improves traceability and allows for systematic quality control and model refinement procedures.

In another embodiment, the server can maintain multiple generative AI models with different sizes or domain specializations and select a model based on context. For example, the server can use a smaller, faster model for simple reformattings and a larger, more accurate model for complex legal amendments. The server may implement a model-selection algorithm that uses features such as input length, detected legal complexity, and required output type. This reduces processing time and computation costs by avoiding unnecessary use of high-capacity models, which constitutes a technical improvement in resource allocation and system efficiency.

In a further embodiment, the server performs pre-and post-filters that reduce noise and improve precision of generated amendments. For instance, before constructing a prompt sentence for amendment generation, the server may run a rule-based consistency checker that verifies whether external law revision information conflicts with already applied amendments or with decommissioned regulations. If conflicts are detected, the server adds explicit instructions in the prompt sentence requesting the generative AI model to harmonize language or to maintain precedence rules. This hybrid of rule-based and model-based processing ensures higher-quality amendment document data, reduces the need for manual corrections, and improves system-level reliability.

The system achieves technical effects that go beyond straightforward automation of human legal drafting. The structured extraction of regulation-related elements and targeted prompt construction reduces input size for generative AI processing and decreases network and computation load. The version-controlled storage format and indexed retrieval allow fast and accurate resolution of which regulation is applicable at a given time. The integrated logging with explicit associations among external sources, prompt sentences, model outputs, and final formal regulation information provides traceability that is not practical to maintain manually. The combination of rule-based selection, transformer-based generative modeling, and post-alignment algorithms yields more consistent and contextually accurate regulation amendments and explanations, improving computational precision and lowering error rates compared to naive or purely manual approaches.

The server, by executing the described modules and algorithms, thus improves the operation of the computer system as a whole. Specifically, the server optimizes data flow between external information sources, internal regulation repositories, generative AI models, and user terminals, achieving reductions in latency, increases in throughput, and improvements in correctness and consistency of stored regulation information. The terminal, by providing structured interfaces for approvals and queries, enables efficient human-computer interaction while the server performs the complex computational tasks necessary to maintain an up-to-date, accurately versioned, and explainable body of regulations.

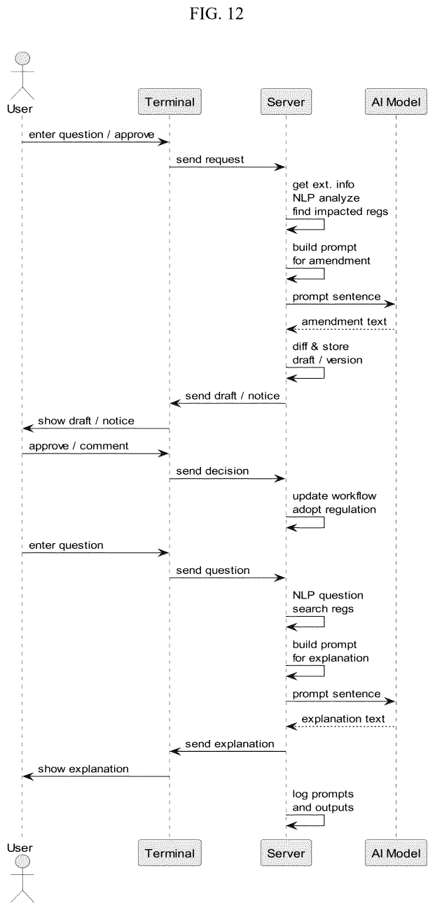

The following describes the processing flow using FIG. 12.

### Step 1:

The server acquires external information from external information sources.

The server uses a communication module to send HTTPS requests to a legal information source and a personnel information source at predetermined intervals or upon trigger events. As input, the server receives API endpoint URLs, authentication tokens, and query parameters specifying a date range or document type. The server performs network I/O operations, receives JSON or XML responses, and parses these responses into internal data objects. As output, the server generates normalized external information records containing fields such as source identifier, document type, effective date, and raw text, and stores these records in a database.

### Step 2:

The server normalizes and stores the acquired external information.

The server takes the parsed external information records as input and applies a normalization function that maps source-specific fields to a canonical schema. The server performs data conversion operations, such as converting date formats, unifying encoding to UTF-8, and mapping law identifiers and role identifiers to internal identifiers. The server writes the normalized records into structured database tables, performing insert or update operations within database transactions. As output, the server maintains consistent, queryable external information tables indexed by document type, effective date, and source.

### Step 3:

The server analyzes external document data using a language processing program.

The server reads raw text from the external information records as input and passes the text to a natural language processing pipeline. The server executes tokenization, sentence splitting, part-of-speech tagging, dependency parsing, and named entity recognition. The server performs computational operations that generate, for each token, tags and dependency relations, and for each sentence, a list of recognized entities, such as law names, article numbers, organizational roles, dates, and obligations. As output, the server produces structured analysis data objects and stores them in association with the original external document identifiers in the database.

### Step 4:

The server extracts regulation-related elements from the analyzed external information.

The server uses the structured analysis data as input and applies rule-based filters and scoring functions. The server evaluates patterns such as “shall,” “must,” “is required to,” role names, and references to specific activities, and computes relevance scores using lexical overlap and entity type matches. The server selects sentences and clauses whose scores exceed a threshold and classifies them into element types such as obligation, prohibition, condition, or role assignment. As output, the server generates a set of regulation-related elements with metadata including trigger tokens, associated roles, and referenced clauses, and stores these elements in a dedicated table.

### Step 5:

The server identifies impacted internal regulation information.

The server takes the regulation-related elements and internal regulation information as input. The server executes database queries and full-text searches to retrieve internal clauses that reference the same legal bases, roles, or key terms as the external elements. The server computes similarity scores using vector representations of text, such as embeddings, and compares them against a threshold. Based on these computations, the server marks specific regulation records as impacted by setting a “needs_revision” flag and associating them with the corresponding external elements. As output, the server produces a list of impacted internal regulation identifiers linked to external change identifiers.

### Step 6:

The server constructs a prompt sentence for amendment generation.

The server uses the regulation-related elements and the text of the impacted internal regulations as input. The server concatenates instruction text, external legal text, and internal regulation text following a predefined template. The server performs string operations, such as inserting delimiters and labels (for example, “Instruction,” “New Regulation Text,” “Current Internal Regulation”), and truncates or summarizes parts if the total length exceeds a configured maximum. The server may invoke the language processing program again to summarize long sections. As output, the server generates a prompt sentence tailored to the generative AI model, ready to be sent via an API request.

### Step 7:

The server invokes a generative AI model to generate amendment document data.

The server takes the constructed prompt sentence as input and converts it into a request payload for an AI service API. The server sends the prompt sentence over HTTPS to a generative AI model endpoint and receives a response containing generated text. The server performs JSON parsing to extract the generated text portion and treats this text as amendment document data. The server may apply simple validation rules, such as checking for required headings or clauses. As output, the server produces a draft regulation amendment, stored as amendment document data associated with the impacted internal regulation identifiers.

### Step 8:

The server prepares the amendment document data for workflow processing.

The server uses the draft amendment document data and the previous version of the internal regulation as input. The server computes a text difference between the new and old versions, for example by applying a diff algorithm, and annotates insertions and deletions. The server then formats the result into a data structure suitable for presentation, with fields for unchanged text, added text, and removed text. As output, the server generates a review package that includes the amendment text, diff annotations, and metadata about the external changes, and registers this package in the workflow mechanism.

### Step 9:

The server initiates and manages an electronic approval workflow.

The server uses the review package and organization-specific approval rules as input. The server reads role definitions and determines a list of approvers based on attributes such as department and responsibility type. The server creates workflow tasks in the workflow system, assigns them to selected approvers, and sets deadlines. The server generates notification messages, such as emails or in-app alerts, that include links or identifiers to the review package. As output, the server populates the workflow system with tasks and sends notification messages to terminal devices associated with approvers.

### Step 10:

The user reviews and acts on amendment document data via a terminal.

The user receives a notification on a terminal as input, such as “A new amendment to the data protection policy is awaiting your approval.” The terminal displays the message and, upon user selection, retrieves the review package from the server. The terminal renders the amendment text, highlighting added and removed sections, and displays explanatory notes if provided. The user reads the content and selects an action (approve, reject, request changes) and optionally enters comments. As output, the terminal sends an approval decision payload, including decision type, comments, and user identifier, back to the server.

### Step 11:

The server processes approval decisions and adopts formal regulation information.

The server takes the approval decision payload and current workflow state as input. The server verifies user identity and authorization, updates the workflow task status, and checks whether all required approvals have been received. The server executes logical evaluations to determine if conditions for adoption are met. If so, the server writes the amendment document data as a new version of formal regulation information into the regulation repository, sets validity period information, and closes the workflow. As output, the server maintains updated formal regulation records and a completed workflow record linked to the external information and prompts.

### Step 12:

The server generates and distributes notification information about updated regulations.

The server uses the new formal regulation information and a list of affected users or organizational units as input. The server composes notification messages containing a summary of changes, effective date, and references to specific sections. The server formats the messages for different channels, such as email text or in-app notification payloads, and sends them via appropriate messaging systems. As output, the server generates and transmits notification information to terminal devices, enabling users to become aware of updated regulations.

### Step 13:

The user submits a question about regulation content via a terminal.

The user views a query interface on the terminal, such as a search or chat screen, as input context. The user types a natural-language question, for example, “What rules apply to using personal data on a personal laptop when working remotely?”, and confirms submission. The terminal captures the question sentence, attaches session identifiers and user identifiers, and sends this data to the server. As output, the terminal provides a structured query payload to the server for processing.

### Step 14:

The server analyzes the question sentence and retrieves relevant regulation document data.

The server takes the question sentence and internal regulation information as input. The server applies the language processing program to the question sentence to extract topic information, such as key phrases and entities. The server then executes search queries using the extracted topics against the regulation repository and full-text indexes. The server ranks the retrieved clauses based on relevance scores computed from lexical and semantic similarity measures. As output, the server obtains a set of relevant regulation document data segments that correspond to the user's question.

### Step 15:

The server constructs a prompt sentence for generating an explanation.

The server uses the user's question and the retrieved regulation document data as input. The server builds a structured text sequence that includes a description of the task, the full or summarized regulation text, and the user's question, with explicit instructions. For example, the server forms a prompt sentence such as: “The following is our organization's data protection policy: ‘[policy text]’. A user has asked: ‘[user question]’. Explain which rules apply to the user's situation in clear, non-legal language and provide concrete examples.” The server ensures that the prompt stays within a token limit by truncating or summarizing long sections. As output, the server generates a prompt sentence suitable for explanation generation.

### Step 16:

The server invokes the generative AI model to generate explanation document data.

The server sends the constructed prompt sentence as input to the generative AI model via an API call. The server receives the model's output as a sequence of tokens and reconstructs it into text. The server may apply basic post-processing such as trimming excessive whitespace or adding section headers. As output, the server produces explanation document data that contains an answer tailored to the user's question, referencing specific clauses and providing examples based on the regulation document data.

### Step 17:

The server delivers and the terminal displays the explanation to the user.

The server uses the explanation document data and session identifiers as input. The server packages the explanation in a response payload and sends it back to the terminal. The terminal receives the payload, parses the explanation text, and displays it in the query interface, optionally alongside the original question and related regulation excerpts. As output, the user sees a structured, plain-language explanation and can decide whether to submit follow-up questions.

### Step 18:

The server records log information for traceability and analysis.

The server takes as input the prompt sentences, the outputs produced by the generative AI model, associated external information identifiers, internal regulation identifiers, user identifiers, and timestamps. The server constructs log entries containing these elements and writes them to a log storage subsystem, using an index structure that supports queries by time, source, or content. The server may also compute statistical summaries, such as counts of amendments generated or common query topics. As output, the server maintains a comprehensive, searchable log that links prompts, generative AI outputs, external changes, internal regulations, approvals, and notifications.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional regulation management systems mainly store regulation texts and simple revision logs in tabular form. In such systems, a processor typically records revision entries in a database and displays the entries as static lists on a terminal device. As a result, several technical problems arise in the context of computer-implemented governance support.

First, the processor does not structure revision history data in a manner optimized for interactive, time-series visualization. Revision records are often retrieved as flat datasets without dedicated visualization-oriented metadata, so a terminal device must perform heavy client-side processing to transform generic tabular data into a time-series representation. This causes increased processing load on the terminal device, inefficient use of network resources due to non-optimized data transfer formats, and degraded responsiveness of the user interface when the number of revisions grows.

Second, conventional systems do not integrate generative AI models into the core revision management architecture. When a user wants an explanation or summary of complex revision histories, the user or an external application must manually assemble input data, construct a prompt sentence, and call an external AI service in an ad hoc manner. Because the processor is not configured to systematically generate AI-ready prompt sentences based on structured revision history data, the system cannot reliably produce consistent, context-rich inputs to a generative AI model. This leads to inconsistent AI outputs, duplicated processing to prepare data for AI consumption, and additional latency and complexity in the overall data processing pipeline.

Third, the processor in typical systems is not configured to couple the storage and retrieval of revision history data with AI-based analysis as a unified computational workflow. Data storage, data visualization, and AI-based explanation are handled as separate, loosely connected functions. As a consequence, the system fails to exploit the stored revision data to improve computer-based analysis workflows, such as automated generation of explanatory information, summaries, or governance-related insights on demand. The system therefore cannot efficiently support dynamic, interactive analysis of revision histories, and cannot adapt the data processing path to AI consumption patterns.

Accordingly, there is a need for a computer-implemented system in which a processor is specifically configured to: (i) store and manage regulation revision history data in a structure suitable for chronological management and time-axis visualization; (ii) generate visualization data that is directly consumable by a terminal device for efficient time-series rendering; and (iii) automatically generate and transmit structured prompt sentences to a generative AI model, based on user inquiries and stored revision history data, so that the system can automatically obtain explanatory or summary information. By tightly integrating these functions, the invention aims to improve the overall performance, responsiveness, and utility of a computer-based regulation management system, thereby providing a concrete improvement in the functioning of the computer system itself rather than merely automating a human mental process.

The specific processing by the specific processing unit 290 of the data processing device 12 in Example 2 is realized by the following means.

The present invention provides a server comprising a processor, a storage device, and an interface to a terminal device and to a generative AI model, wherein the processor is configured to (i) generate a first prompt sentence for instructing generation of a regulation revision proposal based on change information of an external rule or change information of an internal position, (ii) transmit the first prompt sentence as input data to the generative AI model and obtain, from the generative AI model, the regulation revision proposal generated based on the first prompt sentence, (iii) store, in an information management structure in the storage device, revision history data including regulation revision content, revision reason, reviser information, and revision date and time, and manage the revision history data in chronological order, (iv) generate revision list data and visualization data optimized for time-axis display based on the revision history data acquired from the information management structure, and transmit the revision list data and the visualization data to the terminal device for visual rendering, and (v) generate, based on inquiry information from a user and/or the revision history data, a second prompt sentence that includes at least a part of the revision history data and instructs the generative AI model to generate explanatory information or summary information regarding a revision history of a regulation, transmit the second prompt sentence to the generative AI model, obtain the explanatory information or the summary information generated by the generative AI model, and provide the explanatory information or the summary information to the terminal device. This enables the server to structurally manage regulation revision history data for chronological visualization, to offload visualization-oriented processing from the terminal device, and to automatically generate and supply AI-ready prompt sentences and corresponding AI-generated explanations as part of a unified data processing workflow, thereby improving the technical performance, efficiency, and responsiveness of a computer-based regulation management system.

The term “processor” refers to a hardware processing unit or a combination of hardware processing units, such as one or more central processing units or other computing circuitry, that executes instructions to perform functions of the system.

The term “storage device” refers to a hardware memory component or combination of components, such as a semiconductor memory, a magnetic storage medium, or an optical storage medium, that stores data and programs used by the processor.

The term “terminal device” refers to an information processing apparatus, such as a client computer, a portable communication device, or another user interface device, that communicates with the server and presents information to a user.

The term “generative AI model” refers to a machine-learned model, such as a neural network-based language model, that generates output data including text or other content based on input data including a prompt sentence.

The term “prompt sentence” refers to a text string or structured text data that is provided as an input to the generative AI model and that specifies instructions, context, or constraints for generating output data.

The term “external rule” refers to a rule, regulation, statute, guideline, or other normative information defined outside of an organization and applicable to the organization's activities.

The term “internal position” refers to a role, title, or status of a person or entity within an organization, including management positions or other organizational roles that are associated with responsibility for regulations.

The term “change information” refers to data indicating that a state of an external rule or an internal position has been modified, including information about the content of the modification and the time of the modification.

The term “regulation” refers to an internal rule, policy, standard, or procedure defined by an organization to govern operations, behavior, or processes within the organization.

The term “revision proposal” refers to proposed content for modifying an existing regulation, including suggested additions, deletions, or changes to the regulation.

The term “business processing system” refers to an electronic workflow or application system that executes business processes such as approval flows, notifications, or document routing related to regulations.

The term “revision history data” refers to structured data representing past changes to a regulation, including at least regulation revision content, revision reason, reviser information, and revision date and time.

The term “regulation revision content” refers to information describing the specific change made to a regulation, including new text, removed text, or edited text of the regulation.

The term “revision reason” refers to information indicating a cause, justification, or background for changing a regulation.

The term “reviser information” refers to data identifying a person, department, or other entity responsible for performing or authorizing a regulation revision.

The term “revision date and time” refers to temporal information indicating when a regulation revision occurred or was recorded by the system.

The term “information management structure” refers to a logical data structure, such as a table, index, or schema, stored in the storage device for organizing and managing revision history data.

The term “chronological order” refers to an arrangement of data based on time, such that records are ordered according to their associated dates and times.

The term “revision list data” refers to data generated from the revision history data that represents a collection of revision entries in a format suitable for listing or aggregated display.

The term “visualization data” refers to data formatted to facilitate graphical or time-series representation of revision history on the terminal device, including position information, time-axis mapping information, and display attributes.

The term “time axis” refers to a representation of time as a dimension along which revision events are arranged so that their relative temporal positions are visually recognizable.

The term “inquiry information” refers to information received from a user, including a question, request, or instruction, that specifies a desired analysis, explanation, or summary related to regulation revisions.

The term “explanatory information” refers to text or other content that explains the meaning, impact, or context of regulation revisions in a form understandable to a user.

The term “summary information” refers to text or other content that condenses multiple regulation revisions or complex details into a shorter, abstracted representation.

The term “diagram information” refers to graphical representation data, including shapes, lines, labels, and layout information, suitable for rendering visual elements on a display screen.

The term “visualization library” refers to a software component or collection of software components that, when executed in a program execution environment of the terminal device, generates graphical outputs such as charts, timelines, or diagrams from input data.

The term “program execution environment” refers to a software environment on the terminal device, such as a runtime environment or browser engine, that executes application code including the visualization library.

The term “display screen” refers to a visual output device or a surface of such a device on the terminal device, on which images, text, and diagrams are presented to the user.

The term “analysis support information” refers to information generated by processing, including by the generative AI model, that assists the user in analyzing regulation revisions and governance-related aspects, including explanations, summaries, or suggested viewpoints.

The term “governance” refers to management and oversight activities of an organization, including establishing, maintaining, and auditing regulations and compliance processes.

In one embodiment, a server, a terminal, and a generative AI model cooperate to implement the claimed system. The server includes at least one processor, a main memory, a non-volatile storage device, and a network interface. The terminal includes a display screen, an input device, a communication interface, and a program execution environment such as a web browser. The generative AI model is deployed on a computing platform that includes one or more processors, one or more graphics processing units, and an interconnect network, and is accessible from the server via a communication network.

The server executes an operating system such as a general-purpose server operating system and executes application software implemented as a web application. The server uses a database management system such as a relational database management system stored on the storage device. The server stores regulation data and revision history data in a set of tables defined by an information management structure. For example, the server uses a table for regulations and a table for regulation revisions, each table including columns corresponding to regulation identifiers, regulation texts, revision contents, revision reasons, reviser information, and revision dates and times. The server further maintains indexes on the revision date and time column and the regulation identifier column to support efficient retrievals in chronological order or by regulation.

The terminal executes a web browser that includes a JavaScript engine and a rendering engine. The terminal obtains user interface content from the server via a secure communication protocol. The terminal executes a visualization library such as a JavaScript-based data visualization library inside the browser. The visualization library operates on the program execution environment of the terminal and converts received revision list data and visualization data into diagram information that can be rendered on the display screen.

The server generates prompt sentences and communicates with the generative AI model through an application programming interface. The generative AI model is, in one example, a transformer-based neural network language model trained on tokenized text data. The model includes multiple layers of self-attention and feed-forward sublayers, and stores learned parameters in matrix form in the model storage. The server sends input tokens representing a prompt sentence to the generative AI model, and the generative AI model performs numerical computation on the tokens to generate output tokens that are decoded into explanatory information or summary information.

In one detailed configuration, the server defines an information management structure for revision history data as follows. The server defines a revision history table that includes at least: a revision identifier, a regulation identifier, a revision content field, a revision reason field, a reviser identifier, and a revision timestamp. The server defines an index composed of the regulation identifier and the revision timestamp to enable efficient retrieval of revisions in chronological order per regulation. The server further defines a derived structure, such as a materialized view or a precomputed aggregate, that stores for each regulation a compact list of revision identifiers sorted by revision timestamp. The server uses this structure to create revision list data optimized for time-axis visualization.

The server generates visualization data separate from the raw revision history data. The server computes, for each revision entry, a normalized time position based on the revision timestamp. The server maps the revision timestamp to a scalar value representing a position along a time axis using a linear transformation that takes the minimum and maximum timestamps for a selected regulation as reference points. The server encodes, in the visualization data, these scalar positions, together with display attributes such as marker shapes and colors that depend on attributes of the revision, for example, a type of change or a category of the regulation. The server transmits the revision list data and the visualization data to the terminal in a format that reduces client-side processing requirements.

The terminal receives the revision list data and the visualization data and uses the visualization data directly to determine where to place graphical markers along a time axis on the display screen. The terminal uses the visualization library to bind revision entries to graphical objects such as circles or rectangles on an axis. Since the server has already computed normalized time positions and display attributes, the terminal avoids computing complex scaling functions and reduces processing load. This division of processing improves rendering speed, especially when the number of revisions is large, and reduces latency observed by the user.

The server generates prompt sentences in a structured manner. The server retrieves relevant revision history data from the storage device based on inquiry information received from the terminal. For example, the server receives from the terminal a user question such as “Explain the latest changes to the work rules in simple terms.” The server extracts a subset of revision entries that match the question, for example, the most recent revisions for a specific regulation or revisions within a given time range. The server formats the selected revision entries into a normalized textual format, including date, reviser, and concise revision content. The server then constructs a prompt sentence that includes both an instruction portion and a data portion.

In one example, the server constructs a prompt sentence as follows:
“You are an AI assistant that explains internal regulation revisions for corporate governance.
The user asked: ‘Explain the latest changes to the work rules in simple terms.’
Here is the revision history data:
1. 2025-01-10, Reviser: Human Resources Department, Content: Changed the core working hours from 10:00-15:00 to 11:00-16:00. Reason: To support flexible working styles.
2. 2025-03-5, Reviser: Human Resources Department, Content: Introduced a remote work allowance for employees working from home more than 3 days a week. Reason: To improve employee satisfaction and productivity.
Please summarize these changes in plain language that any employee can understand.”

The server converts this prompt sentence into tokens according to a tokenizer specified by the generative AI model. The server then calls the generative AI model through a network interface, including model name, token sequence, and inference parameters such as a temperature parameter and a maximum token limit. The generative AI model performs self-attention computations layer by layer, applying learned weights to the token representations. The generative AI model calculates for each output position a probability distribution over possible next tokens, using a softmax function over a linear transformation of the hidden representation. The generative AI model then selects next tokens based on this probability distribution and the temperature parameter and produces an output sequence of tokens. The server receives the output sequence, decodes the tokens into a text string, and identifies this text as explanatory information or summary information.

The server stores intermediate results of the generative AI model interaction, such as the prompt sentence and the generated explanatory information, in the storage device. The server may index the explanatory information by regulation identifier and time range, enabling subsequent reuse of the generated explanation without re-invoking the generative AI model for identical or similar inquiries. This caching reduces computational load on the generative AI model hardware and improves system responsiveness.

The server, in another embodiment, uses additional rule-based processing to control the content and structure of the prompt sentence. The server applies a set of prompt construction rules, which may include: limiting the number of revision entries included in a prompt, summarizing long revision contents to a fixed maximum length before insertion into a prompt, and encoding categorical tags that indicate regulatory areas such as employment, safety, or compliance. The server thereby creates prompt sentences that are tailored to the generative AI model's context window and are optimized to elicit focused responses. This rule-based construction differs from a simple concatenation of human-readable logs and improves both the technical quality of the prompt and the efficiency of model execution.

The server, in one embodiment of the generative AI model, uses a transformer network trained with supervised learning on text corpora that include regulation-like documents and explanatory texts. The training process uses an objective function such as cross-entropy loss between predicted tokens and ground-truth tokens. The server or another training system performs gradient-based optimization methods, such as stochastic gradient descent with adaptive learning rates, to update model weights. The training pipeline may include data preprocessing, tokenization, batching, and data augmentation steps such as random masking or permutation of sentences to improve generalization. The resulting trained model encodes domain-relevant knowledge and is capable of producing consistent explanations of regulation changes when given structured prompts generated by the server.

The server improves computer technology by restructuring how regulation revision data is stored, processed, and used for AI-based explanation. The server performs optimized database operations that organize revision history data in time-indexed structures. The server precomputes visualization parameters that reduce processing requirements on the terminal. The server generates structured, AI-ready prompt sentences that integrate curated revision data, thereby improving inference efficiency of the generative AI model. These combined operations reduce network traffic, because the server sends visualization-ready data instead of full raw data sets, and reduce redundant AI inference, because the server reuses previously generated explanations when appropriate. As a result, the system achieves improved throughput, reduced latency, and more precise control of computational resources compared to systems that simply log text revisions and call AI services in an ad hoc manner.

The terminal interacts with the server to display revision history and AI-generated explanations. The terminal displays on the screen a time-axis representation of revisions, where each revision is associated with a marker at a position corresponding to its revision timestamp and labeled with basic information such as a revision title. The terminal accepts user input such as a selection of a regulation, a time range, or a request for AI-based explanation. The terminal sends these parameters to the server. The terminal then receives, from the server, explanatory information generated by the generative AI model and displays the explanation adjacent to the timeline or in a separate panel. The terminal thus serves as a thin client, and the bulk of data processing and AI interaction is centralized within the server, enabling consistent handling of revision history and AI prompts.

The user operates the terminal to input new regulation revisions. The user enters revision content, revision reason, and other metadata using an input form presented by the terminal. The terminal transmits this input data to the server. The server validates and sanitizes the input, generates a revision timestamp, and writes a new row into the revision history table in the database. The server updates indexes and any derived structures, such as the revision list per regulation, immediately or asynchronously. The server thereby maintains a coherent and query-efficient dataset for revision history.

The server, in another embodiment, integrates additional analysis functions that exploit the structured revision history data and the generative AI model. The server may generate prompt sentences that request anomaly detection or compliance risk assessment on sequences of revisions. For example, the server may create a prompt sentence such as: “Analyze the following sequence of regulation changes related to working hours and identify any potential compliance risks or inconsistencies.”

The server appends a list of revisions ordered by timestamp. The generative AI model then generates text describing possible risk points or inconsistencies. The server stores this analysis as part of analysis support information and links it to the corresponding revision sequence. The user can then view, through the terminal, not only the raw revision history but also machine-generated guidance on governance issues.

The server, in another variation, uses a combination of conventional algorithms and generative AI processing. The server computes numerical features from revision history data, such as counts of revisions per time interval, distribution of reviser identifiers, and frequency of specific regulatory categories. The server may use these features as additional context fields in the prompt sentence, thereby providing the generative AI model with structured numeric or categorical information. This combined approach allows the system to leverage traditional data processing for quantifiable aspects of governance and use the generative AI model for narrative explanations.

The system provides technical effects that go beyond mere automation of human tasks. The system improves data management by storing revision history data in structures optimized for chronological querying and visualization. The system improves computational efficiency by precomputing visualization parameters and centralizing AI prompt generation and model interaction. The system reduces communication load by transmitting lean, visualization-oriented data from the server to the terminal and by caching AI results. The system improves accuracy and consistency of explanations by generating standardized prompt sentences that reliably provide the generative AI model with relevant, structured context. These improvements arise from specific algorithmic steps and data structures within the server that are not inherent in generic regulation management or generic AI usage.

In alternative embodiments, the server may use different database systems or different visualization libraries, but still applies the same principles of storing revision history data in a time-indexed structure, computing visualization data on the server, and generating structured prompt sentences that embed revision history data. The generative AI model may have different architectures, such as a recurrent neural network or a hybrid model that combines transformer layers with convolutional layers, provided that the model receives a prompt sentence and outputs explanatory information or summary information. The training method may use different optimization algorithms or regularization techniques, such as dropout, weight decay, or batch normalization, yet the core behavior remains that the model transforms tokenized prompt sentences into predicted tokens representing explanations.

In another embodiment, the terminal may be a dedicated application instead of a web browser, and the visualization library may be a native graphics library. The terminal, however, still receives visualization data and revision list data from the server, and still uses that data to render diagrams. The server remains responsible for generating prompt sentences and communicating with the generative AI model. The user continues to operate the terminal to view revision histories and request explanations.

In a further embodiment, multiple servers may share responsibilities. One server may handle storage of revision history data and generation of visualization data, while another server may specialize in interaction with the generative AI model. The servers may communicate via an internal network. Despite the distribution, the logical functions of storing revision history data, generating visualization-ready data, constructing prompt sentences, and obtaining explanatory outputs from the generative AI model remain as described. This distributed configuration can improve scalability and fault tolerance.

Through these embodiments and variations, the server, the terminal, and the generative AI model collectively implement a concrete technological solution. The system is configured not only to automate the recording and display of regulation revisions but also to reorganize data structures, optimize data flow, and integrate a generative AI model in a structured and efficient manner. This configuration results in specific improvements in processing speed, data handling efficiency, visualization performance, and explanatory accuracy in a computer-based regulation management system.

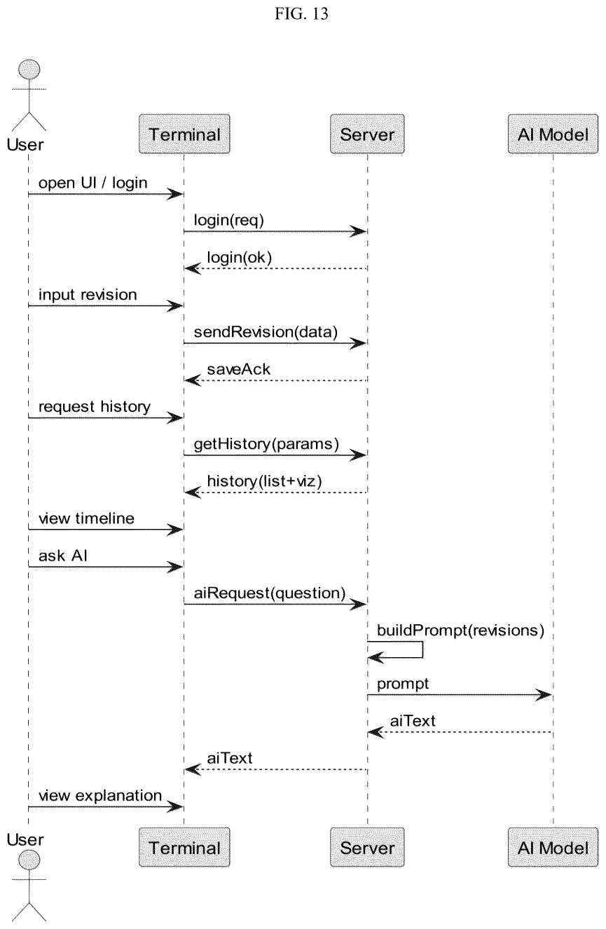

The following describes the processing flow using FIG. 13.

### Step 1:

The user operates the terminal to access a regulation management screen and to log in to the system. The terminal sends login information including a user identifier and authentication data to the server as input. The server performs a comparison operation between the received authentication data and stored authentication records in a storage device to confirm validity, and the server outputs a login success or failure status to the terminal.

### Step 2:

The user operates the terminal to open a regulation revision input screen. The terminal requests screen data from the server as input. The server reads layout information and regulation metadata from the storage device, performs a data composition operation to generate an input form definition, and outputs screen data describing input fields such as regulation name, revision content, revision reason, and reviser information to the terminal. The terminal renders the input form on the display screen as output.

### Step 3:

The user operates the terminal to enter regulation revision content, a revision reason, and reviser information into the displayed form. The terminal collects the entered text strings and metadata as input. The terminal packages the collected data into a structured request and outputs the structured request to the server.

### Step 4:

The server receives the structured request containing revision data from the terminal as input. The server performs validation operations, including checking for required fields, checking data type conformity, and normalizing date and time formats. The server generates a revision timestamp based on a system clock. The server then executes an insertion operation into a revision history table in the storage device, thereby outputting stored revision history data including the revision content, revision reason, reviser information, and revision timestamp.

### Step 5:

The server updates an information management structure that indexes revision history data. The server takes the newly stored revision history entry as input, calculates an index key composed of a regulation identifier and the revision timestamp, and performs an index insertion operation in the information management structure. As output, the server maintains an updated, time-indexed revision history dataset optimized for chronological queries.

### Step 6:

The user operates the terminal to request a display of revision history for a selected regulation or time range. The terminal sends a display request containing a regulation identifier and optional time filter parameters to the server as input. The server performs a query operation on the information management structure using the regulation identifier and time filter, retrieves matching revision records in chronological order, and outputs revision list data representing ordered revision entries to the terminal.

### Step 7:

The server generates visualization data from the retrieved revision list data. The server receives the ordered revision list data as input, computes for each revision a normalized time position by applying a linear mapping from actual revision timestamps to a numerical axis, and assigns display attributes such as marker shape and color based on revision attributes. The server outputs visualization data that includes, for each revision, the normalized time position and display attributes, together with the revision list data, to the terminal.

### Step 8:

The terminal receives the revision list data and visualization data from the server as input. The terminal executes a visualization library in a program execution environment and performs a binding operation between revision entries and graphical objects. The terminal uses the normalized time positions in the visualization data to calculate pixel coordinates on a time axis, draws markers and labels on the display screen, and outputs a rendered timeline that visually represents revision history.

### Step 9:

The user interacts with the timeline displayed on the terminal to select a particular revision event or to change the time range. The terminal receives user interaction events such as clicks, taps, or drag operations as input. The terminal determines which revision entries correspond to the interaction coordinates, performs a lookup in the revision list data, and outputs detailed revision information such as full revision content and revision reason on the display screen.

### Step 10:

The user operates the terminal to request an AI-based explanation or summary of revision history. The terminal collects inquiry information, such as a text question “Explain the latest changes to the work rules in simple terms,” as input. The terminal sends the inquiry information, together with context parameters like regulation identifier and time range, to the server and outputs an AI explanation request.

### Step 11:

The server receives the AI explanation request from the terminal as input. The server performs a filtered query operation on the revision history data, using the regulation identifier and time range included in the request, and selects a subset of revision entries that are relevant to the inquiry. The server formats the selected entries into a normalized textual representation, including date, reviser, and concise revision descriptions, and outputs formatted revision text suitable for inclusion in a prompt sentence.

### Step 12:

The server constructs a prompt sentence for the generative AI model. The server takes as input the inquiry information and the formatted revision text, concatenates an instruction portion and a data portion according to predefined prompt construction rules, and performs a string composition operation to generate a prompt sentence. As one example, the server may generate the following prompt sentence as output:
“You are an AI assistant that explains internal regulation revisions for corporate governance.
The user asked: ‘Explain the latest changes to the work rules in simple terms.’
Here is the revision history data:
1. 2025-01-10, Reviser: Human Resources Department, Content: Changed the core working hours from 10:00-15:00 to 11:00-16:00. Reason: To support flexible working styles.
2. 2025-03-05, Reviser: Human Resources Department, Content: Introduced a remote work allowance for employees working from home more than 3 days a week. Reason: To improve employee satisfaction and productivity.
Please summarize these changes in plain language that any employee can understand.”

### Step 13:

The server prepares input for the generative AI model by tokenizing the prompt sentence. The server receives the prompt sentence as input, applies a tokenizer associated with the generative AI model, performs a lexical segmentation and mapping operation from characters to token identifiers, and outputs a sequence of token identifiers representing the prompt sentence.

### Step 14:

The server transmits the token sequence and inference parameters to the generative AI model as input. The generative AI model performs numerical computation using a transformer-based neural network architecture. The generative AI model propagates the token sequence through multiple attention layers and feed-forward layers, calculates context-aware hidden vectors, and computes a probability distribution over vocabulary tokens at each output position. The generative AI model samples or selects tokens according to the probability distribution and specified temperature parameter, and outputs a sequence of output token identifiers representing explanatory information or summary information.

### Step 15:

The server receives the output token sequence from the generative AI model as input. The server performs a decoding operation that maps token identifiers back to text strings using a vocabulary table. The server concatenates decoded tokens into a coherent text and outputs AI-generated explanatory information or summary information as a text response.

### Step 16:

The server optionally stores the prompt sentence and the AI-generated explanatory information in the storage device. The server uses the regulation identifier, time range, and inquiry pattern as input keys, performs an indexing operation, and outputs cached AI results linked to specific revision histories. This cached data can be reused for subsequent similar inquiries.

### Step 17:

The server sends the AI-generated explanatory information or summary information to the terminal as input to the terminal. The terminal receives the explanatory text, updates the user interface layout, and outputs the explanatory text on the display screen adjacent to or in association with the timeline visualization, thereby allowing the user to view both the graphical revision history and the textual explanation.

### Step 18:

The user reviews the displayed explanation and may refine the inquiry by operating the terminal to request additional analysis, such as a request to focus on a specific category of revisions or to compare two time periods. The terminal sends refined inquiry information to the server as input. The server reuses stored revision history data and, when applicable, cached AI results, or constructs a new prompt sentence and repeats tokenization and model inference. The server thereby outputs refined explanatory information or comparative summary information, which the terminal displays to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional rule-management systems for organizations typically store regulatory texts in structured repositories and provide static, manually authored updates when laws or internal roles change. These systems suffer from several technical shortcomings.

First, existing systems are not architected to automatically transform heterogeneous regulatory change data and organizational change data into machine-interpretable representations that can drive consistent rule revision generation. They generally treat change information as unstructured text that must be manually interpreted by human operators, which leads to latency, inconsistency, and error-prone updates. From a computing-technology perspective, the processing pipeline does not exploit automated natural language analysis and machine-generated text to reduce the computational burden and coordination cost of maintaining large rule corpora.

Second, conventional systems lack an integrated mechanism to generate and manage prompt sentences for a generative AI model as first-class computational artifacts. In existing architectures, any use of a generative model is typically ad-hoc, with prompts being manually crafted outside the system and not systematically optimized based on machine-readable feedback. As a result, the text generation process is opaque to the system, cannot be adaptively tuned, and does not improve over time, which limits the reliability and repeatability of AI-assisted rule revision.

Third, known systems provide little or no support for emotion-adaptive interaction at the system level. User interfaces may display the same static content regardless of a user's comprehension state or emotional state. Conventional architectures do not combine: (i) automated emotion estimation from text, audio, or image streams; (ii) dynamic adjustment of generative-model prompts; and (iii) runtime modification of the structure and detail level of rule explanations and revision histories. Consequently, computer resources are not used to tailor explanations or history views to the user's current cognitive load, leading to inefficient human-computer interaction and poor understanding of complex regulatory changes.

Fourth, conventional rule-management platforms typically separate workflow approval, revision history, and user-facing explanations into loosely connected modules. They do not maintain a unified, machine-readable linkage among (a) original rules, (b) AI-generated drafts, (c) approval decisions, (d) revision history records including text diffs, and (e) downstream explanations delivered to end users. This fragmented design prevents the computing system from programmatically exploiting revision histories and feedback signals to refine future prompts and outputs. In particular, there is no feedback loop in which user interaction data and evaluation data are automatically fed back into the prompt-design layer to improve the behavior of the generative AI model for subsequent operations.

Accordingly, there is a need for an improved computer-implemented system that (1) automatically identifies rule segments requiring revision from regulatory and organizational change data; (2) systematically generates and manages prompt sentences for a generative AI model to create rule revision drafts and explanations; (3) integrates approval workflow and structured revision history management in a way that produces machine-readable difference and chronology information; and (4) uses emotion recognition and user feedback to adapt both the prompts and the generated outputs. Such a system should improve the functioning of the underlying computing environment by reducing manual interpretation, by enabling consistent, reproducible AI-assisted text generation, and by dynamically adjusting the level and style of information presented to users based on real-time signals.

The specific processing by the specific processing unit 290 of the data processing device 12 in Application Example 2 is realized by the following means.

The present invention provides a server comprising a processor configured to (i) acquire regulatory change information and organizational role change information from external and internal information sources and parse the acquired information with natural language processing to identify rule data records that require revision; (ii) generate, for each identified rule data record, a structured prompt sentence that instructs a generative AI model to propose a revised rule text, input the prompt sentence into the generative AI model, receive generated text including the revised rule text, and store the generated text as a rule revision draft linked to the corresponding rule data record; (iii) distribute the stored rule revision draft to stakeholder terminals via a workflow subsystem, receive approval information or correction information from the stakeholder terminals, and update the status of the rule revision draft based on the approval information or the correction information; (iv) upon approval, register the revised rule text as official rule data in a rule storage, store revision history data linking pre-revision and post-revision texts, compute difference information and chronological information from the stored revision history data, and make the difference information and chronological information available to client terminals; (v) receive, from a user terminal, an inquiry text or a topic text regarding rules, search the rule storage for related rule data, generate an explanation-oriented prompt sentence including the related rule data, input the explanation-oriented prompt sentence into the generative AI model, obtain a rule explanation text from the generative AI model, and transmit the rule explanation text to the user terminal; (vi) perform emotion analysis on at least one of user text, user audio, and user image data to estimate a user emotion state, and dynamically adjust at least one of a detail level, tone, or content structure of the explanation-oriented prompt sentence or the rule explanation text according to the estimated user emotion state; and (vii) collect user interaction history and evaluation data regarding the rule explanation text, generate a meta-prompt sentence for optimizing wording, structure, and output conditions of prompt sentences based on the evaluation data, input the meta-prompt sentence into the generative AI model to obtain a prompt design proposal, and update stored prompt templates according to the prompt design proposal so that subsequent rule revision drafts and rule explanations are generated using refined prompt sentences. This enables the computer system to automatically convert heterogeneous change information into consistent rule revisions, to maintain structured revision histories with machine-readable differences, and to adapt prompts and generated outputs in response to real-time emotion signals and accumulated user feedback, thereby improving the technical performance and usability of rule-management operations executed by the server.

The term “regulatory change information” refers to machine-processable data describing a change in an external norm, such as a law, regulation, guideline, or policy, that can affect the content or applicability of internal rules stored in the system.

The term “organizational role change information” refers to machine-processable data indicating a change in a role, position, responsibility, or reporting line within an organization, which may require modification of internal rules associated with such roles.

The term “external information source” refers to a data providing component outside the managed organization, such as a remote server, database, or web service, from which the system acquires regulatory change information.

The term “internal information source” refers to a data providing component within the managed organization, such as an internal database, directory service, or business application, from which the system acquires organizational role change information or internal rule data.

The term “natural language processing” refers to a set of computer-implemented operations that analyze, segment, and interpret human-readable text in order to extract structured information such as entities, relationships, and semantic features used by the processor.

The term “rule information” refers to digital data representing an internal norm, procedure, guideline, or constraint, including at least a rule identifier and rule text, and optionally metadata such as tags, applicability conditions, and effective dates.

The term “revision target identification unit” refers to a functional configuration of the processor that determines, based on regulatory change information or organizational role change information, which rule information records require modification.

The term “prompt sentence” refers to a structured natural-language input string that instructs a generative AI model to perform a specific text generation task, such as producing a draft revised rule or producing an explanation of a rule.

The term “generative AI model” refers to a parameterized machine learning model configured to receive a prompt sentence and output generated text, and that has been trained on text data to perform natural-language generation or transformation.

The term “generated text” refers to output character data produced by the generative AI model in response to a prompt sentence, including at least one of a proposed revised rule text, an explanation text, or an example text.

The term “rule revision draft” refers to generated text representing a candidate modified version of existing rule information, which has not yet been finalized as an official rule and is subject to review and approval.

The term “revision draft generation unit” refers to a functional configuration of the processor that generates prompt sentences for rule revision, invokes the generative AI model with the prompt sentences, and stores resulting generated text as rule revision drafts.

The term “business processing system having an electronic workflow function” refers to a computer-implemented workflow management subsystem that can present tasks to stakeholders, collect their responses, and record task states, and that can be accessed via a network.

The term “stakeholder terminal” refers to an information processing device operated by a person having authority to review, approve, or modify rule revision drafts, and capable of communicating with the server over a network.

The term “approval processing unit” refers to a functional configuration of the processor that distributes rule revision drafts to stakeholder terminals, receives approval information or correction information, and updates status values associated with the drafts.

The term “approval information” refers to digital data indicating that a stakeholder has accepted a rule revision draft, optionally including comments, timestamps, and user identification information.

The term “correction information” refers to digital data indicating that a stakeholder has modified or requested modification of a rule revision draft, including edited text and optionally comments and reasons.

The term “rule data storage device” refers to a logical or physical data storage component that maintains official rule information records in a persistent manner for retrieval and use by the processor.

The term “revision history data storage device” refers to a logical or physical data storage component that maintains records of historical versions of rule texts, including associations between pre-revision and post-revision texts and related metadata.

The term “revision history information” refers to data describing one or more changes to rule information over time, including at least previous text, updated text, timestamps, and optionally reasons and approver identifiers.

The term “difference information” refers to structured data that expresses textual differences between two rule versions, such as added portions, removed portions, or modified portions, in a machine-interpretable format.

The term “chronological information” refers to data that represents the temporal order of rule revisions, such as timestamps, version identifiers, and sequences, enabling time-based access to rule history.

The term “revision history management unit” refers to a functional configuration of the processor that stores revision history information, computes difference information and chronological information, and supplies such information to client devices.

The term “user terminal” refers to an information processing device operated by an end user who consumes rule explanations or revision histories, and that communicates with the server to send inquiries and receive responses.

The term “inquiry text” refers to a text string received from a user terminal that expresses a question, request, or topic relating to rules managed by the system.

The term “topic text” refers to a text string representing a subject matter or keyword of interest specified by a user, used as a basis for locating relevant rule information.

The term “explanation-oriented prompt sentence” refers to a prompt sentence that instructs the generative AI model to generate an explanation of one or more rules, rather than a proposed revision of such rules.

The term “rule explanation text” refers to generated text that describes, in natural language, the content, meaning, or application of one or more rules, possibly including examples and clarifications.

The term “rule explanation providing unit” refers to a functional configuration of the processor that receives inquiry text or topic text, finds relevant rule information, generates explanation-oriented prompt sentences, calls the generative AI model, and returns rule explanation text to user terminals.

The term “emotion analysis” refers to computer-implemented operations that estimate an emotional or affective state of a user based on input data such as text, audio, or images.

The term “user emotion state” refers to a classification or score representing the emotional condition of a user, such as confusion, anxiety, calmness, or satisfaction, determined by emotion analysis.

The term “emotion adaptive control unit” refers to a functional configuration of the processor that modifies at least one of a prompt sentence, a rule explanation text, or a display parameter according to a user emotion state.

The term “detail level” refers to a parameter or characteristic indicating the amount of information, granularity, or depth included in text presented to a user.

The term “tone” refers to a stylistic quality of generated text, such as formality, politeness, or degree of reassurance, that affects how the information is perceived by the user.

The term “content structure” refers to an arrangement of sections, headings, lists, and ordering of information within generated text.

The term “notification information” refers to data summarizing a rule revision, a newly effective rule, or another event of interest, suitable for presentation as an alert or message on a user terminal.

The term “notification distribution server” refers to a server or network service that transmits notification messages from the system to user terminals using a push or messaging protocol.

The term “revision notification unit” refers to a functional configuration of the processor that creates notification information regarding rule revisions or newly effective rules and causes distribution of corresponding messages to user terminals.

The term “image information of a user” refers to digital image data, such as still images or video frames, captured from a user and suitable for analysis to infer visual cues of emotion.

The term “audio information of a user” refers to digital audio data, such as voice recordings, captured from a user and suitable for analysis to infer vocal cues of emotion.

The term “additional explanation text” refers to generated text that supplements an existing rule explanation or history view with further background, purpose, or application examples, typically in response to a user emotion state.

The term “display format” refers to one or more parameters governing how information is visually presented on a user terminal, including layout, font emphasis, and presence or absence of expanded sections.

The term “evaluation data” refers to stored data representing user interactions and explicit or implicit assessments of rule explanations or other system outputs, including ratings, comments, and behavioral signals.

The term “meta-prompt sentence” refers to a prompt sentence directed to the generative AI model for the purpose of obtaining a proposal on how to design or modify other prompt sentences, rather than for generating rule content directly.

The term “prompt design proposal” refers to generated text from the generative AI model that suggests modifications or templates for prompt sentences to improve the behavior of the generative AI model in subsequent uses.

The term “prompt template” refers to a stored, parameterized form of a prompt sentence that can be instantiated with specific rule texts, user questions, or other variables for repeated use.

The term “rule revision draft generation process” refers to a sequence of computer-implemented operations by which the system generates and manages rule revision drafts using prompt sentences and the generative AI model.

The term “rule explanation providing process” refers to a sequence of computer-implemented operations by which the system generates and delivers rule explanation texts to user terminals based on user inputs and rule data.

In one embodiment, a server, a terminal, and a user cooperate to implement the claimed system. The server is implemented as one or more physical computing devices including at least one central processing unit (CPU), a main memory, a non-volatile storage device, a network interface, and optionally a graphics processing unit (GPU) or tensor processing unit (TPU) for accelerating neural network computations. The terminal is implemented as a mobile communication device, a tablet device, a desktop computer, a notebook computer, or a head-mounted display, and includes a display, an input interface such as a keyboard, a touch panel, a microphone, and a camera, and a communication interface. The user is a human operator who interacts with the terminal and indirectly controls operations of the server.

Server executes a server-side application program that is stored in the non-volatile storage device and loaded into the main memory. Server may execute an operating system and a web application framework such as a generic server framework, a database management system such as a relational database, and middleware for calling external web services. The relational database stores rule data, revision history data, prompt templates, user feedback data, and configuration data as described below.

Server stores rule data in a rule data storage device configured as a relational table structure. In one example, server maintains a “rules” table including, for each rule, a rule identifier, a current rule text field, a rule type field, a tag field, an applicability condition field, an effective date field, and a status field. Server also maintains a “revision_history” table including, for each revision, a history identifier, a rule identifier, a pre-revision text field, a post-revision text field, a change reason field, a timestamp field, an approver identifier field, and a source change identifier field.

Server executes natural language processing using software such as a general-purpose natural language processing library. Server converts unstructured text strings obtained from external information sources and internal information sources into structured representations, such as token sequences, part-of-speech tags, dependency trees, and named entity annotations. Server uses these linguistic features to identify which rule records may be affected by a given regulatory change or organizational role change.

Server calls one or more generative AI models that are implemented as neural networks on a remote model serving platform or on a local accelerator. In one embodiment, the generative AI model is a transformer-based neural network including an input embedding layer, a plurality of self-attention layers, feed-forward layers, and an output layer that predicts token probabilities over a vocabulary. The model accepts a prompt sentence encoded as a sequence of token identifiers and produces generated text as a sequence of token identifiers. Server decodes the token identifiers into a character string that is stored as generated text.

Server trains or fine-tunes the generative AI model before deployment using supervised learning. Server prepares training data that includes pairs of input prompt sentences and target output texts, such as desired rule revisions or desired rule explanations. Server defines a loss function such as a cross-entropy loss between predicted token distributions and target tokens. Server updates model parameters using an optimization algorithm, such as stochastic gradient descent or an adaptive gradient method, and adjusts learning rate and other hyperparameters to reduce the loss. Server may perform data augmentation by rephrasing prompts, adding variations in instruction text, or mixing multiple change descriptions, in order to increase robustness and diversity of model responses.

Server stores prompt templates in a “prompt_templates” table. Each prompt template includes a template identifier, a template type field (for example, revision, explanation, meta-prompt), a template text field containing fixed text with placeholders, and a parameter schema describing how to populate the placeholders with rule text, change descriptions, user emotion states, and other parameters. Server uses these templates to construct concrete prompt sentences at runtime by filling in placeholders with specific values. This data-driven design allows server to systematically modify templates in response to meta-level optimization results and to apply changes consistently across different operations.

Server implements emotion analysis using trained models for sentiment classification or emotion classification. In one embodiment, server uses a text-based emotion classifier implemented as a neural network that accepts tokenized user text and outputs an emotion label among, for example, “calm,” “confused,” “anxious,” and “satisfied.” The classifier is trained using labeled text data with corresponding emotion labels, and server uses a loss function such as cross-entropy to update classifier parameters. In another embodiment, server uses an audio-based classifier that extracts features such as Mel-frequency cepstral coefficients from user speech and feeds them into a recurrent neural network or a convolutional neural network to estimate emotion. In a further embodiment, server or terminal uses a vision-based classifier that receives face images or face landmarks derived from camera frames and applies a convolutional neural network to estimate emotion categories.

Terminal runs a client-side application that communicates with the server via a network using protocols such as HTTPS. Terminal presents graphical user interfaces for viewing current rules, browsing revision histories, and submitting inquiries. Terminal can also capture audio stream data via a microphone and image stream data via a camera. Terminal transmits captured data to the server or to an external emotion recognition service, and receives back emotion labels or scores.

User operates the terminal to input regulatory change descriptions, to review rule revision drafts, to supply approvals or corrections, to submit inquiries, and to provide evaluation feedback. User also consumes the explanations and history views, and relies on the system to understand complex and evolving regulatory environments.

Server acquires regulatory change information and organizational role change information from external and internal information sources. For example, server periodically calls an external web service offering machine-readable law update feeds, and server queries an internal human resources system for role change events. The acquired data is stored in a “change_events” table containing fields such as change identifier, change type, raw text description, source identifier, and acquisition timestamp.

Server applies natural language processing to the raw text description fields. Server tokenizes the text, detects legal citations, extracts numerical values and role names, and computes vector representations of sentences using pre-trained embeddings. Server then matches these extracted entities and vector representations against metadata associated with rules in the “rules” table. Server calculates a relevance score for each rule and selects rules with relevance scores exceeding a configured threshold as candidates for revision. This rule identification process reduces the search space dramatically compared to a naive full-text search and contributes to reduced CPU usage and decreased latency for large rule corpora.

Server generates prompt sentences for rule revision using the stored prompt templates. In one concrete example, server constructs a prompt sentence such as:
“Based on the following law amendment, revise the internal working hours rule. Original rule: ‘Weekly working hours shall not exceed 40 hours.’ Law amendment: ‘Weekly working hours shall not exceed 35 hours.’Output the complete revised clause in formal internal policy style.”

Server encodes this prompt sentence into tokens and forwards the token sequence to the generative AI model. The model performs multiple layers of attention and feed-forward computation to predict the most probable next token at each position, using learned weights and position encodings. As a result, the model generates a revised rule text that is consistent in style and structure with prior training examples. Server decodes the tokens to text and stores the text as a rule revision draft linked to the original rule.

Server also generates explanation-oriented prompt sentences. For example, when user submits a topic such as “About taking paid leave,” server selects the corresponding rule text and constructs a prompt sentence such as:
“Explain the following company paid leave policy in simple language for an employee who asked: ‘About taking paid leave.’ Policy text: ‘Employees are entitled to 10 days of paid leave per year. Approval by the direct manager is required before taking leave.’ Provide a concise explanation and one practical example.”

Server then calls the generative AI model and receives a rule explanation text that describes the rule in simpler terms and includes a concrete example. This explanation text is transmitted to the terminal and presented to user.

Server further constructs emotion-aware prompt sentences by incorporating a user emotion state. For instance, when emotion analysis indicates that the user is anxious about a new regulation, server augments the prompt with explicit tone instructions, such as:
“The user feels anxious about the new working hours regulation. Explain the rule in a clear and reassuring way. Emphasize that support is available for questions. User question: ‘I am worried about the new working hours rule; can you explain how it affects me?’Policy text: [policy text].”

By embedding emotion-related instructions as structured parts of the prompt sentence, server guides the generative AI model to generate output with adjusted detail level and tone, thereby tailoring the response to the user's state. This approach goes beyond human manual editing by enabling a computational feedback loop in which emotion estimates and prompt grammar jointly influence the generation process.

Server integrates approval workflow by interacting with a business processing system that manages tasks and approvals. Server registers rule revision drafts in the workflow system and assigns stakeholder identifiers based on rule metadata. Stakeholders receive draft texts on their terminals, inspect the differences between pre-revision and post-revision rule texts, and input approvals or corrections. Server receives these responses and updates the status field in the “rule_drafts” table. Upon approval, server creates a new entry in the “revision_history” table and updates the “rules” table with the approved text.

Server computes difference information using a string comparison algorithm, such as a sequence alignment method or a diff algorithm, on the pre-revision and post-revision texts. The difference information is stored as a structured patch or as annotated spans indicating inserted, deleted, or modified portions. When terminal requests revision history, server composes chronological information by ordering revision history entries by timestamp and returns both the chronological metadata and the difference information. Terminal then renders a timeline and highlights changed segments on the display.

Server performs meta-level optimization of prompt templates based on collected evaluation data. Terminal presents user with rating interfaces for generated explanations and allows user to submit comments. Server records these evaluations along with emotion states and rule identifiers. Periodically, server constructs a meta-prompt sentence such as:
“Users often feel confused about the overtime policy, especially when reading long explanations. Based on the following feedback snippets, propose improved prompt templates that produce shorter, clearer explanations: [feedback text].”

Server sends the meta-prompt sentence to the generative AI model to obtain a prompt design proposal. The proposal may include alternative phrasings, recommended section structures, or constraints on output length. Server then analyzes the proposal and updates corresponding entries in the “prompt_templates” table. This feedback loop gradually improves the performance of the generative AI model for the specific domain of rule management without retraining the model itself, by systematically refining the prompt layer.

This architecture yields technical effects beyond mere automation of human drafting. By structuring change events, rules, prompts, and feedback as machine-readable records, server reduces the computational complexity of identifying impacted rules. By using neural network-based generative AI models together with explicit prompt templates, server achieves more consistent and predictable rule revisions and explanations compared to ad-hoc model calls. By coupling emotion analysis with prompt adjustment, server dynamically modulates data presentation to user, reducing cognitive overload and error rates when interpreting complex changes. By linking revision histories, diff results, and explanations in a single data model, server enables efficient indexing and retrieval that reduce input/output overhead and network traffic, because only differential segments and summarized information are transmitted when appropriate.

In another embodiment, server implements the generative AI model as a sequence-to-sequence network with encoder-decoder architecture. The encoder transforms the prompt sentence into a vector representation, and the decoder generates output tokens conditioned on this representation. Server may use attention mechanisms between encoder and decoder to focus on relevant portions of the prompt, such as particular law fragments or rule clauses. The network is trained with teacher forcing on parallel text data, and server records training loss over time to monitor convergence.

In a further embodiment, terminal performs part of the emotion analysis locally, particularly for image data. Terminal extracts facial landmarks using a vision model and computes feature vectors that are sent to server in compressed form. This reduces bandwidth and preserves privacy. Server then applies a lightweight classifier on the feature vectors to infer emotion states. By distributing computations between terminal and server, the system balances latency and load, leading to reduced processing time for emotion-adaptive display updates.

In still another embodiment, server differentiates among multiple categories of prompt templates. Revision templates are optimized for accuracy and legal style, explanation templates are optimized for readability, and meta-prompt templates are optimized for clarity in instructing the generative AI model. Server stores separate evaluation statistics for each category and can apply different optimization criteria, such as minimizing misinterpretation for revision templates and maximizing user satisfaction ratings for explanation templates. This separation allows server to tune different aspects of the system independently, improving overall computational efficiency and quality.

User benefits from these technical improvements because user sees up-to-date rules faster, receives explanations that match user's knowledge and emotional state, and can verify how and why rules have evolved through clearly visualized revision histories. The system achieves these outcomes by orchestrating concrete hardware and software components—the server CPU and memory, the terminal sensors and display, the database structures, the neural network parameters, the prompt templates, and the diff algorithms—in a coordinated manner that materially improves data processing and user interaction compared to conventional rule management platforms.

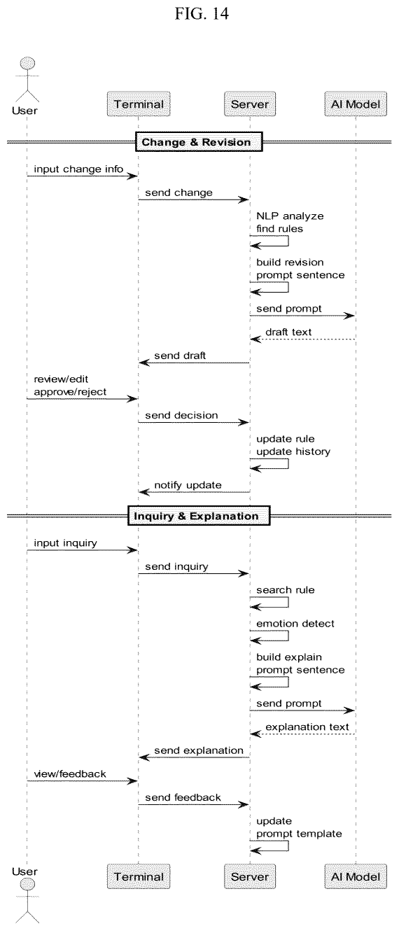

The following describes the processing flow using FIG. 14.

### Step 1:

Server acquires change information and stores it.

Server receives as input regulatory change information and organizational role change information from external information sources and internal information sources via network interfaces. Server parses incoming messages formatted, for example, as JSON, validates schema conformity, and stores each change event into a “change_events” table in a relational database with fields such as change_id, change_type, raw_text, source_id, and timestamp. Server thereby converts raw network packets into structured records that can be indexed and queried efficiently.

### Step 2:

Server performs natural language analysis and identifies impacted rules.

Server reads as input unprocessed change_events records from the database. Server applies natural language processing to the raw_text field, including tokenization, part-of-speech tagging, named entity recognition for law titles, article numbers, roles, and departments, and numerical value extraction. Server then computes similarity scores between extracted entities and metadata fields (tags, titles, references) in the “rules” table by applying string matching, vector similarity, and rule-based filters. Server outputs a list of rule identifiers with associated relevance scores and writes mappings into a “change_to_rule_mapping” table, marking rules with scores above a threshold as revision targets.

### Step 3:

Server prepares structured inputs for revision prompt generation.

Server takes as input the set of rule identifiers marked as revision targets and the corresponding change_events records. Server loads the current rule text for each rule from the “rules” table and compiles a structured object containing original rule text, change description, change type, and applicability metadata. Server normalizes these values by removing markup, truncating excessively long segments, and tagging key spans. Server outputs this normalized structure for each rule as intermediate data to be used in prompt sentence construction.

### Step 4:

Server generates revision prompt sentences.

Server receives as input the normalized structures for revision targets and prompt templates from the “prompt_templates” table whose type is “revision.” Server substitutes placeholders in the template text (for example, {ORIGINAL_RULE}, {CHANGE_DESCRIPTION}) with the actual values of the normalized structure. Server concatenates fixed instructions and variable content to form a complete prompt sentence such as:
“Based on the following law amendment, revise the internal working hours rule. Original rule: ‘Weekly working hours shall not exceed 40 hours.’ Law amendment: ‘Weekly working hours shall not exceed 35 hours.’Output the complete revised clause in formal internal policy style.”

Server outputs, for each revision target, a concrete prompt sentence and stores it in a “generated_prompts” table with a reference to the rule identifier.

### Step 5:

Server calls the generative AI model to obtain rule revision drafts.

Server uses each prompt sentence as input and encodes the prompt text into a sequence of token identifiers using a tokenizer associated with the generative AI model. Server transmits the token sequence, together with generation parameters such as maximum length and temperature, to a model serving endpoint. Inside the model, a transformer network performs multiple layers of self-attention and feed-forward computations to predict token probabilities iteratively and outputs a sequence of generated token identifiers. Server decodes these token identifiers back into text, post-processes the text to remove incomplete trailing segments, and outputs a generated rule revision draft. Server records each draft in a “rule_drafts” table with fields for draft_id, rule_id, prompt_id, draft_text, and initial status “pending_approval.”

### Step 6:

Server initiates workflow tasks for stakeholder approval.

Server takes as input the newly stored rule_drafts entries with status “pending_approval” and corresponding rule metadata specifying required approver roles. Server composes a task payload including original rule text, draft_text, change reason, and deep link identifiers, and sends this payload via an API to a workflow subsystem. Server receives task identifiers in return and updates the “rule_drafts” table to store these workflow task identifiers. The output is a set of active workflow tasks each associated with a rule revision draft.

### Step 7:

Terminal retrieves pending approval tasks and presents them to a stakeholder.

Terminal receives as input from server a list of draft_ids and associated metadata for which the current user is identified as an approver. Terminal displays a summary list showing, for each draft, the rule title, a short change summary, and the task status. When user selects a draft, terminal requests the full original text and draft_text from server and renders them in a side-by-side view. The output is a user interface enabling detailed comparison and decision entry.

### Step 8:

User edits and decides on the rule revision draft.

User reviews as input the original rule text and the generated draft_text displayed on the terminal. User may modify the draft_text using a text editor component, where each keystroke updates a local buffer on the terminal. User then selects an “Approve” or “Request changes” control, optionally entering a comment. Terminal packages the edited text, the decision flag, and the comment as a structured message and outputs this message to server via an HTTPS request.

### Step 9:

Server updates draft status and, if approved, publishes the new rule version.

Server receives as input the decision message from the terminal containing draft_id, edited_text, decision, and comments. Server writes the edited_text into the “rule_drafts” record, updates the status field to “approved” or “rejected,” and logs decision details in an “approval_log” table. If the decision is approval, server copies the current text of the rule from the “rules” table into a pre_revision field, updates the rule's text field with the approved edited_text, and inserts a new record into “revision_history” capturing pre-revision, post-revision, and metadata. The output is a consistent update to both live rule data and revision history data.

### Step 10:

Server computes difference information and chronological metadata.

Server uses as input pairs of pre-revision and post-revision texts from newly created revision_history records. Server applies a diff algorithm, which aligns sequences of characters or tokens and marks insertions, deletions, and modifications. Server represents each difference as a structured element containing positions and change types, and stores these elements as a JSON or binary field associated with the revision_history record. Server also updates ordering fields such as version numbers and maintains a per-rule sequence of revisions. The output is enriched revision history data including both difference information and chronological information.

### Step 11:

Server generates notification payloads for affected users.

Server reads as input approved revision_history records and associated rule metadata specifying affected departments or roles. Server queries user profiles to obtain lists of user terminals that correspond to these departments or roles. Server composes a notification payload containing a title, a concise change summary, and a deep link URI pointing to the revised rule or its history. Server outputs these payloads to a notification distribution server that delivers push messages to the corresponding terminals.

### Step 12:

Terminal receives and displays revision notifications.

Terminal receives as input push messages from the notification distribution server containing notification payloads. Terminal interprets the payload to extract title, summary, and deep link, and displays a notification banner or alert to user. If user activates the notification, terminal uses the deep link to request the corresponding rule or history view from server and navigates directly to that screen. The output is a contextually focused display of updated rule information.

### Step 13:

User submits a topic or inquiry regarding rules.

User inputs as text on the terminal a query such as “About taking paid leave” or “Explain the new security policy.” Alternatively, user speaks an utterance, and terminal converts the audio into text using a speech recognition component. Terminal validates the text for non-emptiness and length limits and sends the text, together with user_id and current context, as input to server. The output from the terminal is a structured inquiry message containing inquiry_text or topic_text.

### Step 14:

Server searches rule data and constructs explanation-oriented prompt sentences.

Server receives as input the inquiry message from the terminal. Server applies tokenization and semantic analysis on the inquiry_text, extracts key concepts, and queries the “rules” table using both keyword matching and vector similarity search to retrieve candidate rules. Server ranks candidates and selects one or more top rules, then retrieves their texts and relevant recent revisions. Server loads an explanation-type prompt template from the “prompt_templates” table and fills in placeholders with the user's inquiry, rule text, and optional context such as examples. Server outputs a specific explanation-oriented prompt sentence such as:
“Explain the following company paid leave policy in simple language for an employee who asked: ‘About taking paid leave.’ Policy text: ‘Employees are entitled to 10 days of paid leave per year. Approval by the direct manager is required before taking leave.’ Provide a concise explanation and one practical example.”

### Step 15:

Server analyzes the user's emotional state from text and other inputs.

Server uses as input the inquiry_text and, when available, additional user data such as recent comments, captured audio, or facial images transmitted from the terminal. Server processes text through a sentiment or emotion classifier that outputs probability scores for emotion classes. Server optionally processes audio features and image features through separate neural networks and fuses these outputs using a weighted combination or another fusion algorithm. Server determines a user emotion state such as “anxious,” “confused,” or “calm” by selecting the class with highest combined probability. The output is a discrete emotion label and optionally a confidence score.

### Step 16:

Server adjusts the explanation-oriented prompt sentence based on emotion.

Server takes as input the initial explanation-oriented prompt sentence and the user emotion state. Server selects or constructs emotion-adaptation phrases, for example, “in a reassuring way” for anxious users or “in concise form” for calm, advanced users. Server inserts these phrases into designated locations in the prompt template, thereby modifying the instructions that will guide the generative AI model. For an anxious user, the resulting prompt may be:
“The user feels anxious about the new working hours regulation. Explain the rule in a clear and reassuring way. Emphasize that support is available for questions. User question: ‘I am worried about the new working hours rule; can you explain how it affects me?’Policy text: [policy text].”

Server outputs this emotion-aware prompt sentence for use in subsequent generation.

### Step 17:

Server obtains a rule explanation text from the generative AI model.

Server uses the adjusted explanation-oriented prompt sentence as input and tokenizes the sentence to a token sequence. Server forwards the token sequence and generation parameters to the generative AI model endpoint. The model performs neural network inference to generate output tokens representing an explanation text that follows the instructions embedded in the prompt. Server decodes the tokens to a character string, performs post-processing such as trimming incomplete sentences and ensuring required sections are present, and outputs the final rule explanation text. Server stores the prompt, output, and associated user_id and emotion label in an “explanation_log” table.

### Step 18:

Terminal presents the rule explanation and optionally collects feedback.

Terminal receives as input the rule explanation text from server. Terminal formats the explanation into sections, such as “Summary,” “Details,” and “Example,” and displays the result in a readable layout. Terminal may additionally offer feedback controls, such as rating buttons and a comment field. User reads the explanation and may submit a rating or comment. Terminal outputs any feedback entered by user as an evaluation message containing explanation_id, rating, and comment.

### Step 19:

Server aggregates evaluation data and user interaction logs.

Server receives as input evaluation messages from terminals. Server records these in a “user_feedback” table tied to explanation_log entries and rule identifiers. Server also tracks implicit interaction signals such as time spent on the page, frequency of scrolling, and whether user requested additional detail. Server aggregates these data points periodically, computing statistics per rule, per template, and per emotion state. The output is a set of evaluation aggregates that quantify user comprehension and satisfaction with system outputs.

### Step 20:

Server generates and applies meta-prompt sentences for prompt optimization.

Server uses as input aggregated evaluation data and representative feedback text. Server constructs a meta-prompt sentence that describes observed issues and desired improvements, for example:
“Users often feel confused about the overtime policy, especially when reading long explanations. Based on the following feedback snippets, propose improved prompt templates that produce shorter, clearer explanations: [feedback text].”

Server tokenizes this meta-prompt and submits it to the generative AI model. The model outputs a prompt design proposal that may include suggestions on phrasing, ordering of sections, or explicit length constraints. Server parses the proposal, identifies concrete template modifications, and updates corresponding records in the “prompt_templates” table. The output is a refined set of prompt templates that will be used in later Steps 4, 14, 16, and 17 to produce higher-quality revisions and explanations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

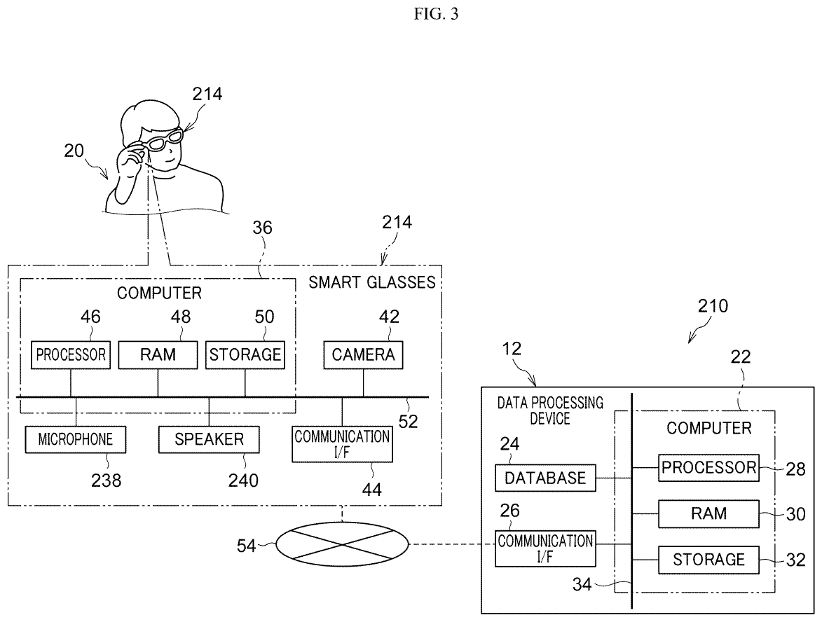

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

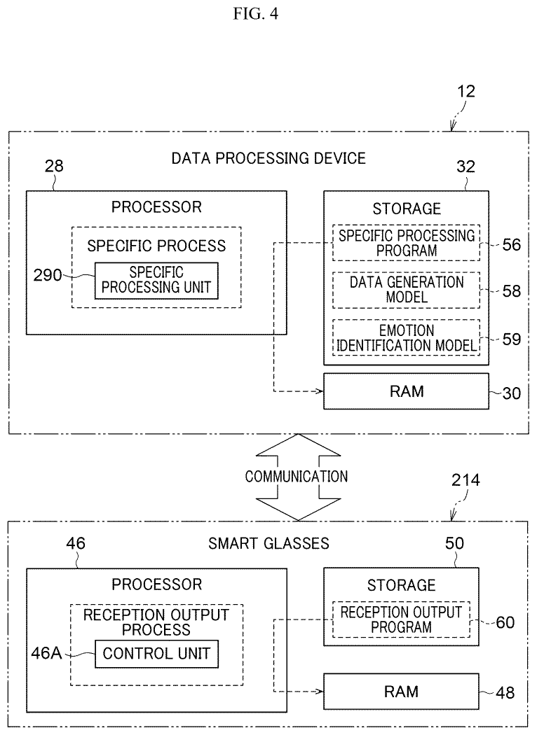

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

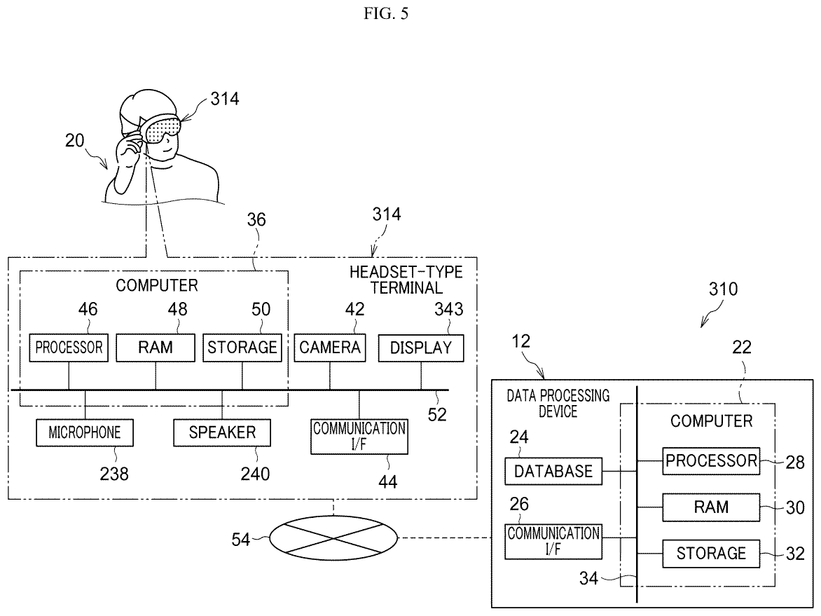

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

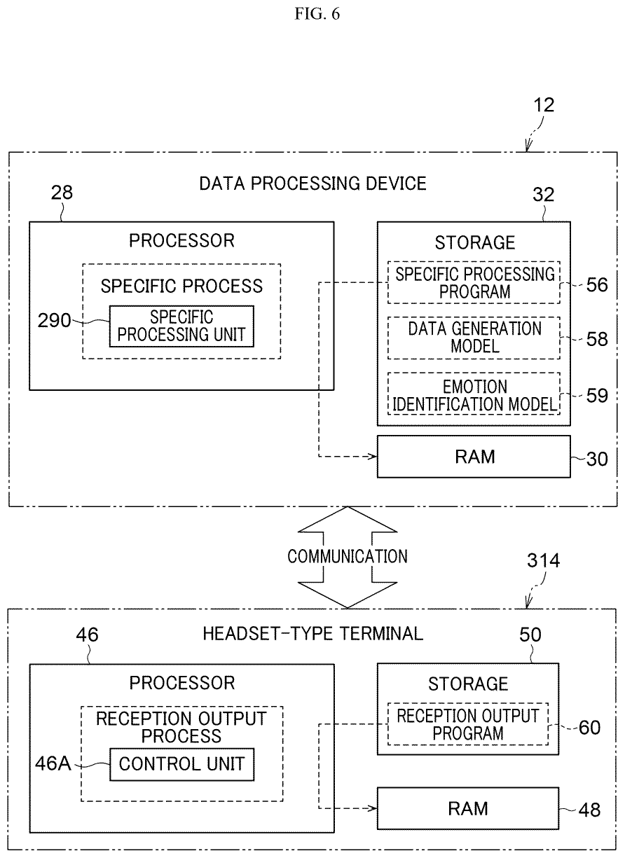

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

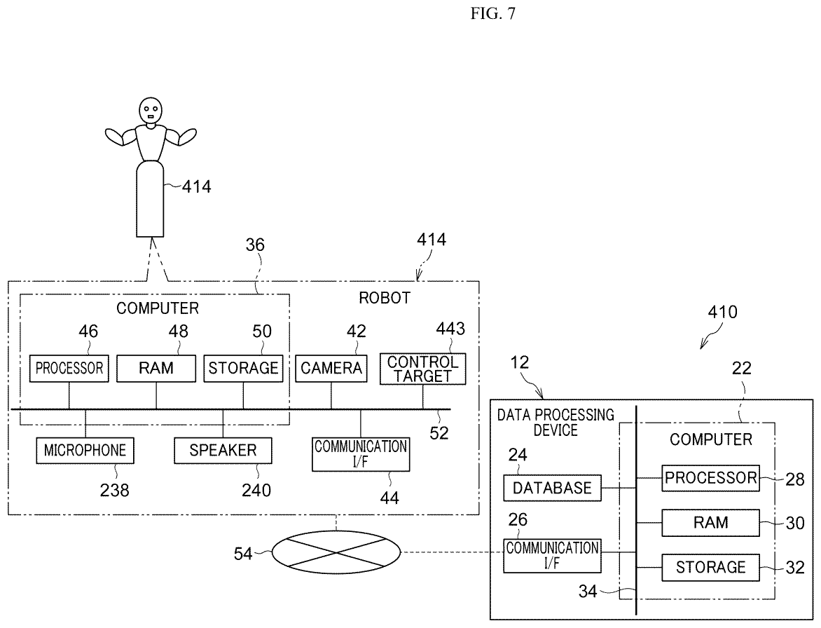

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

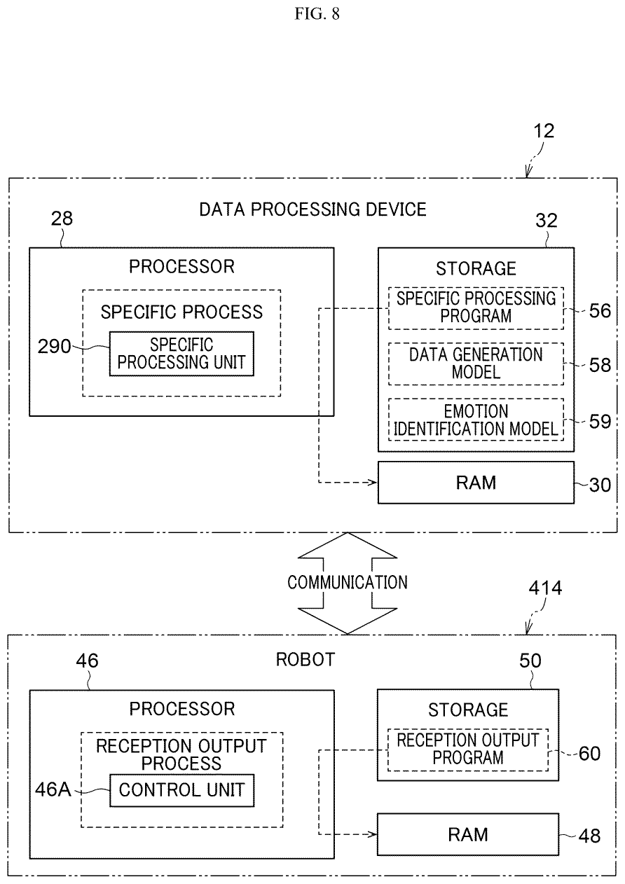

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

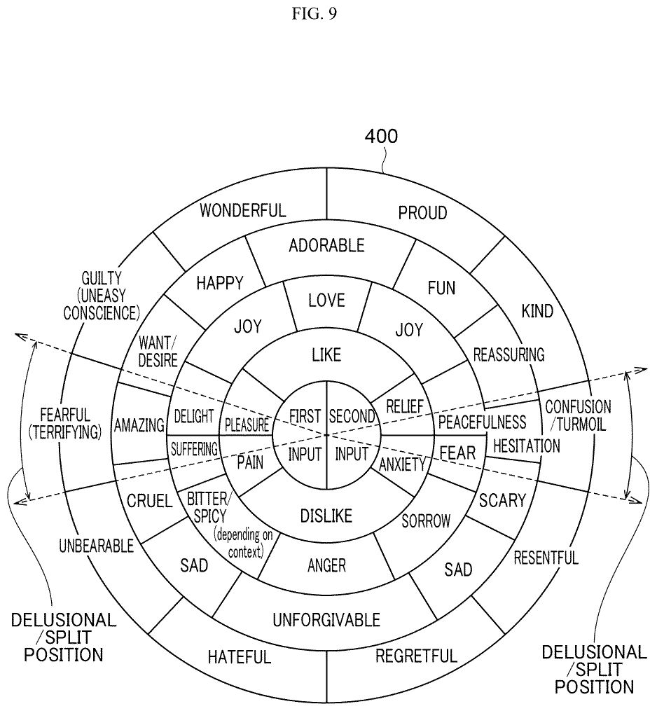

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

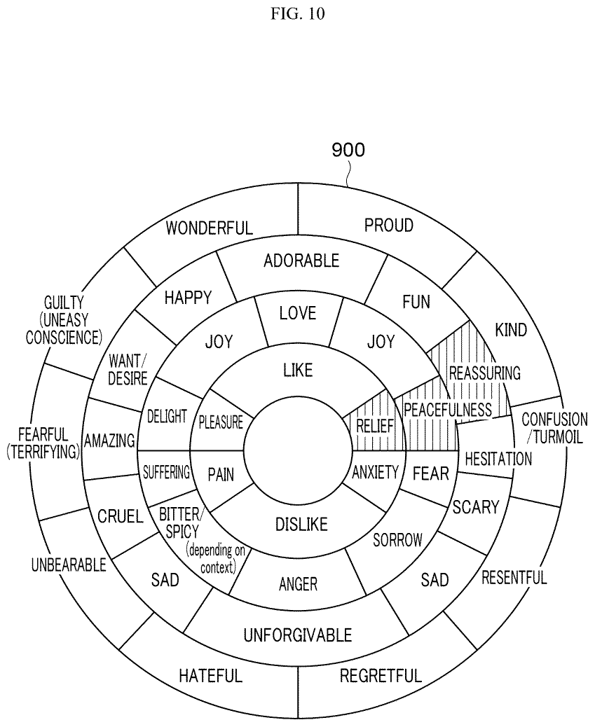

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a storage device,
wherein the processor is configured to
receive input information from a user terminal and store the input information in the storage device,
analyze law change information or intra-organizational position information included in the input information to extract regulation data to be revised from the storage device,
generate a prompt sentence, based on an analysis result and the extracted regulation data, for instructing a generative AI model to generate a draft amendment of a regulation,
transmit the prompt sentence to an external information processing service and receive regulation amendment text generated by the generative AI model,
store the received regulation amendment text as amendment data in the storage device and generate difference information between the amendment data and original regulation data, generate, based on the amendment data and the difference information, approval tasks for respective approvers and notify related terminals of the approval tasks and the amendment data via an electronic workflow, and
update a state of the amendment data based on approval information or modification information received from the related terminals, and, when a predetermined approval condition is satisfied, update the regulation data in the storage device by adopting the amendment data as final regulation data.

### Supplementary 2

The system according to supplementary 1,
wherein the processor is configured to
store, in the storage device, contents of the regulation data for each version and validity periods of the contents as history information in a time-series manner, and, when the amendment data is adopted as the final regulation data, retain old-version regulation data as history data to manage an amendment history.

### Supplementary 3

The system according to supplementary 1,
wherein the processor is configured to
generate, as the prompt sentence, a prompt sentence for instructing the generative AI model to generate application situation information or case information relating to the regulation data, and store, in the storage device, application example text generated by the generative AI model as explanation data that is presentable to the related terminals.

### Application Example 1

### Supplementary 1

A system comprising a processor,
wherein the processor is configured to
perform a communication process with an external information source including a legal information source and a personnel information source, to acquire external information including law revision information and role change information as document data that is a target of regulation revision,
execute, on the acquired document data, a language processing program to perform phrase extraction processing or structural analysis processing, and extract elements related to a regulation revision from the document data,
generate a prompt sentence that instructs creation of a draft regulation amendment on the basis of the extracted elements and internal regulation information stored in a storage medium,
invoke a generative AI model as an information processing model using the generated prompt sentence as input, cause the information processing model to execute generation processing of the draft regulation amendment, and generate amendment document data,
register the generated amendment document data in an electronic workflow mechanism for approval processing, and transmit information prompting confirmation and approval to an approver via the electronic workflow mechanism,
store, in the storage medium, the amendment document data that has been approved on the basis of an approval result acquired from the electronic workflow mechanism, as formal regulation information, associate the formal regulation information with validity period information, and
perform version management of the formal regulation information,
generate notification information including update details of the formal regulation information, and transmit the notification information as an electronic message or a notification signal to a terminal device,
acquire, as input information, a question sentence related to regulation content received from a user via the terminal device, execute the language processing program to extract topic information from the question sentence, and search the internal regulation information stored in the storage medium for regulation document data related to the topic information, and generate a prompt sentence that instructs explanation of the regulation content on the basis of the question sentence and the searched regulation document data, cause the generative AI model to generate explanation document data, and cause the explanation document data to be presented on the terminal device.

### Supplementary 2

The system according to supplementary 1,
wherein the processor is configured to
store, as log information, the prompt sentence input to the generative AI model and the amendment document data or the explanation document data output from the generative AI model, in association with corresponding external information, internal regulation information, approval result information, and notification information, and save and manage the log information in a searchable format.

### Supplementary 3

The system according to supplementary 1,
wherein the processor is configured to
generate, on the basis of the internal regulation information stored in the storage medium and input information received from the user via the terminal device, a prompt sentence that instructs the generative AI model to generate application example document data describing application scenarios of a regulation, and cause the generative AI model to generate the application example document data, and cause the application example document data to be presented on the terminal device as explanatory information of the regulation.

### Example 2

### Supplementary 1

A system comprising a processor, a storage device, and a terminal device,
wherein the processor is configured to
generate a prompt sentence for instructing generation of a revision proposal of a regulation, based on change information of an external rule or change information of an internal position, transmit the prompt sentence as input data to a generative AI model and cause the generative AI model to generate the revision proposal of the regulation based on the prompt sentence, transmit the generated revision proposal to a business processing system and notify a related terminal device of the revision proposal via the business processing system,
store revision history data, including regulation revision content, revision reason, reviser information, and revision date and time, in an information management structure in the storage device, and manage the revision history data in chronological order,
generate revision list data based on the revision history data acquired from the information management structure,
generate visualization data for causing the terminal device to visually display the revision history data along a time axis, and transmit the revision list data and the visualization data to the terminal device, and
generate a prompt sentence for instructing generation of explanatory information or summary information regarding the revision history of the regulation by the generative AI model, based on inquiry information from a user or based on the revision history data, transmit the prompt sentence to the generative AI model, obtain the explanatory information or the summary information generated by the generative AI model, and provide the explanatory information or the summary information to the terminal device.

### Supplementary 2

The system according to supplementary 1,
wherein the processor is configured to cause the terminal device, based on the revision list data received from the processor, to execute a visualization library operating on a program execution environment in the terminal device, to draw the revision history data as diagram information arranged along a time axis on a display screen of the terminal device, and to display detailed information of each revision history in response to an operation by the user. (Supplementary 3)

The system according to supplementary 1,
wherein the processor is configured to extract a part of the revision history data based on the inquiry information from the user, generate a prompt sentence including the extracted revision history data, input the prompt sentence to the generative AI model to cause the generative AI model to generate explanatory information or summary information regarding the revision history of the regulation, and output a generation result as analysis support information regarding governance to the terminal device.

### Application Example 2

### Supplementary 1

A system comprising a processor,
wherein the processor is configured to
acquire regulatory change information or organizational role change information from an external information source or an internal information source, analyze the acquired information by natural language processing, and identify rule information that requires revision, as a revision target identification unit, and
generate, based on the identified rule information and the regulatory change information or the organizational role change information, a prompt sentence that instructs creation of a revised rule text, input the prompt sentence into a generative AI model, obtain generated text including a revised rule text from the generative AI model, and store the obtained generated text as a rule revision draft, as a revision draft generation unit, and
distribute the stored rule revision draft to stakeholder terminals having approval authority via a business processing system having an electronic workflow function, receive approval information or correction information from the stakeholder terminals, and update a status of the rule revision draft based on the approval information or the correction information, as an approval processing unit, and
register an approved rule revision draft as an official rule in a rule data storage device, store revision history information including an association between a pre-revision rule text and a post-revision rule text in a revision history data storage device in association with the official rule, and generate difference information and chronological information based on the revision history information, as a revision history management unit, and
search, based on an inquiry text or a topic text regarding a rule received from a user terminal, for related rule information from the rule data storage device, generate an explanation prompt sentence including the related rule information, input the explanation prompt sentence into the generative AI model, obtain a rule explanation text from the generative AI model, and transmit the rule explanation text to the user terminal for presentation, as a rule explanation providing unit, and
perform emotion analysis processing based on input text, audio information, or image information of a user, estimate a user emotion state, and change a detail level, tone, or content structure of the explanation prompt sentence or the rule explanation text according to the estimated user emotion state, as an emotion adaptive control unit, and
generate notification information regarding the approved rule revision draft or newly effective rule information, and transmit a message including the notification information to a user terminal via a notification distribution server so that the notification information is displayed by the user terminal, as a revision notification unit.

### Supplementary 2

The system according to supplementary 1,
wherein the processor is configured to
execute emotion recognition processing on image information or audio information of a user acquired while a rule display screen or a revision history display screen is being displayed on the user terminal, determine a user emotion state, and, when the determined user emotion state indicates confusion, anxiety, or lack of understanding, use the revision history information stored in the revision history data storage device and the generative AI model to generate additional explanation text including at least one of background explanation, purpose explanation, and application example of a rule revision, and transmit the additional explanation text to the user terminal so as to dynamically change a display format or a detail level.

### Supplementary 3

The system according to supplementary 1,
wherein the processor is configured to
collect inquiry history information regarding rules from users and evaluation information regarding the rule explanation text, store the collected information as evaluation data, generate, based on the evaluation data, a meta-prompt sentence for improving wording, structure, or output conditions of the prompt sentence input to the generative AI model, input the meta-prompt sentence into the generative AI model to obtain a prompt design proposal, and update a template of the prompt sentence according to the prompt design proposal so as to improve accuracy or comprehensibility of a rule revision draft generation process or a rule explanation providing process.

What is claimed is:

1. A system comprising:
circuitry configured to:
receive, via a communication interface coupled to a packet-switched network, input data from a terminal device, the input data including change indication data relating to at least one of an external normative source or an organizational role assignment;
analyze the input data by executing a language processing program to extract, from managed document data stored in a storage device, a subset of the managed document data identified as requiring revision;
generate, based on a result of the analysis and the extracted subset of the managed document data, a prompt sentence for instructing a generative neural network model operating on a deep learning framework to generate revision data;
transmit the prompt sentence to the generative neural network model and acquire the revision data generated by the generative neural network model;
compute difference data between the revision data and the extracted subset of the managed document data, and store the revision data and the difference data in the storage device; and
transmit the revision data and the difference data to one or more associated terminal devices via the communication interface for authorization processing.

2. The system according to claim 1, wherein the circuitry is configured to generate, based on the revision data and the difference data, task data for respective authorization processing entities, and distribute the task data and the revision data to the one or more associated terminal devices via an electronic task distribution pipeline.

3. The system according to claim 2, wherein the circuitry is configured to receive authorization information or modification information from the one or more associated terminal devices, update a state of the revision data based on the received authorization information or modification information, and, when a predetermined authorization condition is satisfied, update the managed document data in the storage device by adopting the revision data as finalized managed document data.

4. The system according to claim 3, wherein the circuitry is configured to store, in the storage device, contents of the managed document data for each version and validity periods of the contents as version history data in a time-series structure, and, when the revision data is adopted as the finalized managed document data, retain previous-version managed document data as history data.

5. The system according to claim 4, wherein the version history data includes, for each version entry, a revision reason, reviser identification information, a revision date and time, and an association between pre-revision content and post-revision content of the managed document data.

6. The system according to claim 5, wherein the circuitry is configured to generate visualization data for causing the terminal device to visually display the version history data arranged along a time axis, and transmit the visualization data to the terminal device via the communication interface.

7. The system according to claim 6, wherein the managed document data comprises a regulation established within an organization, the external normative source comprises a law or ordinance, the organizational role assignment comprises a change of an officer position within the organization, and the electronic task distribution pipeline comprises an electronic workflow system that routes approval tasks to stakeholders.

8. The system according to claim 1, wherein the circuitry is configured to perform a communication process with an external information source via the communication interface to acquire the change indication data, the external information source including at least one of a legal information source and a personnel information source.

9. The system according to claim 8, wherein the circuitry is configured to execute the language processing program on the acquired change indication data to perform at least one of phrase extraction processing and structural analysis processing, and extract elements related to the revision from the change indication data.

10. The system according to claim 9, wherein the circuitry is configured to store, as log data, the prompt sentence transmitted to the generative neural network model and the revision data acquired from the generative neural network model, in association with corresponding change indication data, managed document data identifiers, authorization result information, and notification information, and save the log data in a searchable format in the storage device.

11. The system according to claim 10, wherein the circuitry is configured to generate notification data including update details of the finalized managed document data and transmit the notification data as an electronic message to the one or more associated terminal devices via the communication interface.

12. The system according to claim 1, wherein the circuitry is configured to generate a further prompt sentence for instructing the generative neural network model to generate application example data describing application scenarios of the managed document data, transmit the further prompt sentence to the generative neural network model, acquire the application example data, and store the application example data in the storage device as explanation data presentable to the one or more associated terminal devices.

13. The system according to claim 12, wherein the circuitry is configured to receive, from the terminal device, an inquiry sentence relating to content of the managed document data, execute the language processing program to extract topic information from the inquiry sentence, search the managed document data stored in the storage device for document data related to the topic information, and generate a query prompt sentence based on the inquiry sentence and the searched document data.

14. The system according to claim 13, wherein the circuitry is configured to transmit the query prompt sentence to the generative neural network model, acquire explanation document data generated by the generative neural network model, and transmit the explanation document data to the terminal device via the communication interface for presentation to a user.

15. The system according to claim 1, wherein the circuitry is configured to acquire at least one of text input data, audio information, and image information of a user from the terminal device, and estimate a user emotional state by performing emotion analysis processing on the acquired information using an emotion estimation model.

16. The system according to claim 15, wherein the circuitry is configured to adjust, in accordance with the estimated user emotional state, at least one of a detail level, a tone, and a content structure of the prompt sentence or the revision data, such that when the estimated user emotional state indicates confusion or anxiety, the circuitry generates a simplified prompt sentence that instructs the generative neural network model to produce output with reduced complexity.

17. The system according to claim 16, wherein the circuitry is configured to collect inquiry history data and evaluation data from users regarding generated content, store the collected data in the storage device, generate a meta-prompt sentence based on the collected data for improving wording or structure of subsequent prompt sentences, transmit the meta-prompt sentence to the generative neural network model to obtain a prompt design proposal, and update a template of the prompt sentence according to the prompt design proposal.

18. A system comprising:
circuitry configured to:
receive, via a communication interface coupled to a packet-switched network, input data from a terminal device, the input data including change indication data relating to at least one of an external normative source or an organizational role assignment, and store the input data in a storage device;
execute a language processing program on the input data to perform phrase extraction processing and structural analysis processing, and extract, from managed document data stored in the storage device, a subset of the managed document data identified as requiring revision based on the extracted phrases and structural elements;
generate, based on a result of the extraction and the extracted subset of the managed document data, a prompt sentence that encodes revision requirements as constraint clauses for a transformer-based generative neural network model comprising a plurality of self-attention layers and feed-forward layers;
transmit the prompt sentence to the transformer-based generative neural network model and acquire revision data generated by the transformer-based generative neural network model;
compute difference data between the revision data and the extracted subset of the managed document data by performing a text comparison operation that identifies additions, deletions, and modifications at a segment level, and store the revision data and the difference data in the storage device;
generate, based on the revision data and the difference data, task data for authorization processing and distribute the task data and the revision data to one or more associated terminal devices via an electronic task distribution pipeline; and
update the managed document data in the storage device when a predetermined authorization condition is satisfied, and store contents of the managed document data for each version together with validity period information as version history data in a time-series structure.

19. The system according to claim 18, wherein the transformer-based generative neural network model is trained using supervised learning on a dataset of document revision pairs by minimizing a cross-entropy loss between predicted tokens and reference revision tokens using a gradient-based optimization algorithm, and the circuitry is configured to constrain output of the transformer-based generative neural network model to produce revision data that includes markup indicating positions of additions, deletions, and modifications relative to the extracted subset of the managed document data.

20. A method performed by circuitry of a system coupled to a packet-switched network via a communication interface, the method comprising:
receiving, via the communication interface, input data from a terminal device, the input data including change indication data relating to at least one of an external normative source or an organizational role assignment;
analyzing the input data by executing a language processing program to extract, from managed document data stored in a storage device, a subset of the managed document data identified as requiring revision;
generating, based on a result of the analysis and the extracted subset of the managed document data, a prompt sentence for instructing a generative neural network model operating on a deep learning framework to generate revision data;
transmitting the prompt sentence to the generative neural network model and acquiring the revision data generated by the generative neural network model;
computing difference data between the revision data and the extracted subset of the managed document data, and storing the revision data and the difference data in the storage device; and
transmitting the revision data and the difference data to one or more associated terminal devices via the communication interface for authorization processing.
